(19) United States
(12) Patent Application Publication
(10) Pub. No.: US 2015/0075879 A1
(43) Pub. Date: Mar. 19, 2015

(54) WEIGHING APPARATUS, WEIGHING SYSTEM, WEIGHING METHOD, AND RECORDING MEDIUM

(71) Applicant: TANITA CORPORATION, Tokyo (JP)

(72) Inventors: Yoshio SAKAI, Tokyo (JP); Kazuma INOUE, Tokyo (JP); Atsuo KUMEKAWA, Tokyo (JP)

(73) Assignee: TANITA CORPORATION, Tokyo (JP)

(21) Appl. No.: 14/488,941

(22) Filed: Sep. 17, 2014

(30) Foreign Application Priority Data
Sep. 18, 2013 (JP) 2013-192890

(51) Int. Cl. G01G 3/12; G01G 23/14

(52) U.S. Cl. CPC G01G 3/12; G01G 23/14
USPC 177/1; 177/25.13

(57) ABSTRACT

A weighing apparatus for weighing a mass of an object is provided with: a body; a load receiving device, a load detection device, an acting force detection device, and a data processing device configured to data-process an output of the load detection device as a weighed value in a mass unit. The data processing device has: a load output acquisition unit configured to acquire an output of the load detection device; a force output acquisition unit configured to acquire an output of the acting force detection device; and a correction coefficient calculation unit configured to calculate, as a correction coefficient for correcting an output of the load detection device, a change amount of an output of the load output acquisition unit with respect to a change amount of an output of the acting force detection device based on (i) outputs of the load detection device and the acting force detection device acquired respectively by the load output acquisition unit and the force output acquisition unit, when the weighing apparatus with zero load applied thereto is placed in a first attitude and (ii) outputs of the load detection device and the acting force detection device acquired respectively by the load output acquisition unit and the force output acquisition unit, when the weighing apparatus with zero load applied thereto is placed in a second attitude, which differs from the first attitude.

### CROSS-REFERENCE TO RELATED APPLICATION

Priority is claimed on Japanese Patent Application No. 2013-192890, filed on Sep. 18, 2013, the contents of which are incorporated herein by reference.

### BACKGROUND

1. Field of the Invention

The present invention relates to a weighing apparatus, a weighing system, a weighing method, a program, and a recording medium. In particular, the present invention relates to a weighing apparatus, a weighing system, a weighing method for weighing a mass of an object, a program that causes a computer to function as the weighing apparatus, a program that causes a first computer to function as the weighing apparatus and that causes a second computer to function as a portable information terminal, and a recording medium that records the programs.

2. Background

In weighing apparatus such as scales, an error may occur in some cases due to noise associated with vibration in the measurement environment or the like. In scales, there has been employed a measure in which noise is removed by performing a filtering process on data obtained from a load cell.

Incidentally, vibration in a measurement environment varies from high frequency to low frequency. In particular, low frequency noise may not be removed in some cases, depending on the filtering process. Moreover, an excessive filtering process may deteriorate measurement responsiveness in some cases.

As techniques related to this type of background, various techniques are known (for example, refer to Japanese Patent Application, Publication No. JP2013-2941A).

For example, Japanese Patent Application, Publication No. JP2013-2941A discloses a weighing system which is capable of stabilizing vibration compensation of a weighing sensor, using an accelerometer, which is a sensor different from the weighing sensor. To describe more specifically, this weighing system is provided with a weighing sensor. Moreover, this weighing system is provided with a vibration sensor for detecting an influence of disturbance vibration picked up naturally by the weighing sensor. Furthermore, this weighing system is provided with a first A/D (analog/digital) conversion unit that converts an analog output value from the weighing sensor into a digital output value. Moreover, this weighing system is provided with a second A/D conversion unit that converts an analog output value from the vibration sensor into a digital output value. Furthermore, this weighing system is provided with a correction calculation unit that corrects a digital output value from the second A/D conversion unit so that the digital output value from the second A/D conversion unit conforms to the sensitivity characteristic of a digital output value of the first A/D conversion unit. Moreover, this weighing system is provided with a combining unit that combines the corrected digital output value from the correction calculation unit and the digital output value of the first A/D conversion unit to mitigate influence of disturbance vibration. The digital output value from the second A/D conversion unit undergoes up-sampling before the digital output value from the second A/D conversion unit is corrected by the correction calculation unit. With this weighing system, in this manner, vibration compensation is stabilized, and in addition, increase in installation space and cost are suppressed, compared to a method that uses, as a vibration compensation sensor, the same sensor as the weighing sensor that requires compensation.

### SUMMARY

As described above, the weighing system disclosed in Japanese Patent Application, Publication No. JP2013-2941A is a system that subtracts an output value of the vibration sensor from an output value of the weighing sensor to remove noise, and is extremely effective. This type of weighing system uses the amount of change in the weighing sensor output with respect to the amount of change in the vibration sensor output, as a correction coefficient for correcting the output of the weighing sensor.

However, this type of correction coefficient is calculated, using, for example, a specialized apparatus such as one that applies a standard reference vibration to the scale.

According to an aspect of the present invention, there is a weighing apparatus for weighing a mass of an object, the apparatus comprising: a main body; a load receiving device provided at the main body to receive a load; a load detection device provided to detect a load acting on the load receiving device; an acting force detection device provided to detect a force that is acting on the main body and that differs from the load acting on the load receiving device; and a data processing device configured to data-process an output of the load detection device as a weighed value in a mass unit. The data processing device has: a load output acquisition unit configured to acquire an output of the load detection device; a force output acquisition unit configured to acquire an output of the acting force detection device; and a correction coefficient calculation unit configured to calculate, as a correction coefficient for correcting an output of the load detection device, a change amount of an output of the load output acquisition unit with respect to a change amount of an output of the acting force detection device based on (i) outputs of the load detection device and the acting force detection device acquired respectively by the load output acquisition unit and the force output acquisition unit, for when the main body with zero load applied thereto is placed in a first attitude and (ii) outputs of the load detection device and the acting force detection device acquired respectively by the load output acquisition unit and the force output acquisition unit, for when the main body with zero load applied thereto is placed in a second attitude, which differs from the first attitude.

The data processing device may further have: a frequency determination unit that, in a case where a change occurs in an output of the acting force detection device at the time of weighing, determines whether or not a frequency of the change is smaller than a threshold value; and a change detected time weighed value calculation unit that, in a case where the frequency determination unit determines the frequency as being smaller than the threshold value, treats a value that is calculated by subtracting, from an output of the load detection device, a value obtained by multiplying an output of the acting force detection device by a correction coefficient calculated by the correction coefficient calculation unit, as a weighed value.

The data processing device may further have: an output difference determination unit that determines whether or not an output difference between an output of the acting force detection device when a display is automatically set to zero without intervention of an operator, and an output of the acting force detection device at a time of weighing, is within an acceptable value; and an output difference detected time weighed value calculation unit that, in a case where the output difference determination unit determines the output difference as not being within the acceptable value, treats a value that is calculated by subtracting from an output of the load detection device, a value obtained by multiplying the output difference by a correction coefficient calculated by the correction coefficient calculation unit, as a weighed value.

The data processing device may further have: a span coefficient calculation unit that treats as a span coefficient of the load detection device after shipment, a value that is calculated by multiplying a value obtained by dividing a correction coefficient calculated after shipment by the correction coefficient calculation unit by a correction coefficient calculated before shipment by the correction coefficient calculation unit, by a span coefficient of the load detection unit obtained before shipment.

In the weighing apparatus, at least one of (a) the acting force detection device and (b) at least a part of the data processing device (the load output acquisition unit, the force output acquisition unit, and the correction coefficient calculation unit) may be provided at another body that is different from the main body.

In the weighing apparatus, the acting force detection device may be provided at the another body, the another body may be attachably and detachably provided with respect to the main body, and the acting force detection device detects, while the another body may be attached on the main body, the force that is acting on the main body and that differs from the load acting on the load receiving device.

In the weighing apparatus, the another body may be a portable information terminal.

According to another aspect of the present invention, there is a weighing system comprising: a weighing apparatus configured to measure a mass of an object; a portable information terminal; and a data processing section configured to process data for the measurement, wherein the weighing apparatus comprises: a load receiving unit, and a load detection device arranged to detect a load acting on the load receiving unit, the portable information terminal comprises: an acting force detection device arranged to detect a force that is acting on the weighing apparatus, the data processing section comprises: a load output acquisition unit provided at the weighing apparatus and configured to acquire an output of the load detection device; a force output acquisition unit provided at the portable information terminal and configured to acquire an output of the acting force detection device; and a correction coefficient calculation unit provided at the weighing apparatus or at the portable information terminal and configured to calculate a correction coefficient for correcting an output of the load detection device.

In the weighing system, the system may be arranged such that the portable information terminal is attachably and detachably provided with respect to the weighing apparatus, and the acting force detection device may be arranged to detect, while the portable information terminal is attached on the weighing apparatus, the force that is acting on the weighing apparatus and that differs from the load acting on the load receiving unit.

According to further another aspect of the present invention, there is a weighing system for weighing a mass of an object, the system including: a weighing apparatus that is provided with a load receiving device provided for receiving a load, and a load detection device provided for detecting a load acting on the load receiving device; and a portable information terminal that is attachably and detachably provided on the weighing apparatus, and that is provided with an acting force detection device provided for detecting a force that is acting on the weighing apparatus and that differs from a load acting on the load receiving device. The weighing apparatus has a load output acquisition unit configured to acquire an output of the load detection device; the portable information terminal has a force output acquisition unit configured to acquire an output of the acting force detection device, and a force data transmission unit configured to transmit to the weighing apparatus, force data indicating an output acquired by the force output acquisition unit; and the weighing apparatus further has a force data reception unit configured to receive the force data transmitted from the portable information terminal, and a correction coefficient calculation unit configured to calculate, as a correction coefficient for correcting an output of the load detection device, a change amount of an output of the load detection device with respect to a change amount of an output of the acting force detection device based on (i) an output of the load detection device that is acquired by the load output acquisition unit and an output of the acting force detection device that is shown by force data received by the force data reception unit, for when the portable information terminal is attached on the weighing apparatus with zero load applied thereto and the weighing apparatus is placed in a first attitude, (ii) an output of the load detection device that is acquired by the load output acquisition unit and an output of the acting force detection device that is shown by force data received by the force data reception unit, for when the portable information terminal is attached on the weighing apparatus with zero load applied thereto and the weighing apparatus is placed in a second attitude, which differs from the first attitude.

According to further another aspect of the present invention, there is a weighing system for weighing a mass of an object, the system including: a weighing apparatus that is provided with a load receiving device provided for receiving a load, and a load detection device provided for detecting a load acting on the load receiving device; and a portable information terminal that is attachably and detachably provided on the weighing apparatus, and that is provided with an acting force detection device provided for detecting a force that is acting on the weighing apparatus and that differs from a load acting on the load receiving device. The weighing apparatus has a load output acquisition unit that acquires an output of the load detection device, and a load data transmission unit that transmits to the portable information terminal, load data indicating the output acquired by the load output acquisition unit; and the portable information terminal has a force output acquisition unit that acquires an output of the acting force detection device, a load data reception unit that receives the load data transmitted from the weighing apparatus; and a correction coefficient calculation unit that calculates, as a correction coefficient for correcting an output of the load detection device, a change amount of an output of the load detection device with respect to a change amount of an output of the acting force detection device based on (i) an output of the load detection device that is shown by the load data received by the load data reception unit and an output of the acting force detection device that is acquired by the force output acquisition unit, for when the portable information terminal is attached on the weighing apparatus with zero load applied thereto and the weighing apparatus is placed in a first attitude and (ii) an output of the load detection device that is shown by the load data received by the load data reception unit and an output of the acting force detection device that is acquired by the force output acquisition unit, for when the portable information terminal is attached on the weighing apparatus with zero load applied thereto and the weighing apparatus is placed in a second attitude, which differs from the first attitude.

According to further another aspect of the present invention, there is a weighing method for weighing a mass of an object, the method including: (a) acquiring an output of a load detection device that is provided at a body of a weighing apparatus for detecting a load acting on a load receiving device of the body; (b) acquiring an output of an acting force detection device that is provided for detecting a force that is acting on the body and that differs from a load that is acting on the load receiving device; and (c) calculating, as a correction coefficient for correcting an output of the load detection device, a change amount of an output of the load detection device with respect to a change amount of an output of the acting force detection device based on (i) outputs of the load detection device and the acting force detection device acquired respectively in the step (a) and the step (b), for when the body with zero load applied thereto is placed in a first attitude and (ii) outputs of the load detection device and the acting force detection device acquired respectively in the step (a) and the step (b), for when the body with zero load applied thereto is placed in a second attitude, which differs from the first attitude.

According to further another aspect of the present invention, there is a program that causes a computer to function as a weighing apparatus that weighs a mass of an object, the program causing the computer to function as: a load output acquisition unit that acquires an output of a load detection device that is provided at a body of the weighing apparatus for detecting a load acting on a load receiving device of the body; a force output acquisition unit that acquires an output of an acting force detection device that is provided for detecting a force that is acting on the body and that differs from a load that is acting on the load receiving device; and a correction coefficient calculation unit that calculates, as a correction coefficient for correcting an output of the load detection device, a change amount of an output of the load detection device with respect to a change amount of an output of the acting force detection device based on (i) outputs of the load detection device and the acting force detection device acquired respectively by the load output acquisition unit and the force output acquisition unit, for when the body with zero load applied thereto is placed in a first attitude and (ii) outputs of the load detection device and the acting force detection device acquired respectively by the load output acquisition unit and the force output acquisition unit, for when the body with zero load applied thereto is placed in a second attitude, which differs from the first attitude.

According to further another aspect of the present invention, there is a recording medium that records a program that causes a computer to function as a weighing apparatus that weighs a mass of an object, the recording medium recording a program that causes the computer to function as: a load output acquisition unit that acquires an output of a load detection device that is provided at a body of the weighing apparatus for detecting a load acting on a load receiving device of the body; a force output acquisition unit that acquires an output of an acting force detection device that is provided for detecting a force that is acting on the body and that differs from a load that is acting on the load receiving device; and a correction coefficient calculation unit that calculates, as a correction coefficient for correcting an output of the load detection device, a change amount of an output of the load detection device with respect to the change amount of an output of the acting force detection device based on (i) outputs of the load detection device and the acting force detection device acquired respectively by the load output acquisition unit and the force output acquisition unit, for when the body with zero load applied thereto is placed in a first attitude and (ii) outputs of the load detection device and the acting force detection device acquired respectively by the load output acquisition unit and the force output acquisition unit, for when the body with zero load applied thereto is placed in a second attitude, which differs from the first attitude.

According to further another aspect of the present invention, there is a weighing method for weighing a mass of an object, the method including: (a) acquiring an output of a load detection device by means of a weighing apparatus that is provided with a load receiving device provided for receiving a load, and the load detection device provided for detecting a load acting on the load receiving device; (b) acquiring an output of an acting force detection device by means of a portable information terminal that is attachably and detachably provided on the weighing apparatus, and that is provided with an acting force detection device provided for detecting a force that is acting on the weighing apparatus and that differs from a load acting on the load receiving device; (c) transmitting force data showing the output acquired in the step (b), to the weighing apparatus by means of the portable information terminal; (d) receiving the force data transmitted from the portable information terminal, by means of the weighing apparatus; and (e) by means of the weighing apparatus, calculating, as a correction coefficient for correcting an output of the load detection device, a change amount of an output of the load detection device with respect to a change amount of an output of the acting force detection device based on (i) an output of the load detection device that is acquired in the step (a) and an output of the acting force detection device that is shown by the force data received in the step (d), for when the portable information terminal is attached on the weighing apparatus with zero load applied thereto and the weighing apparatus is placed in a first attitude and (ii) an output of the load detection device that is acquired in the step (a) and an output of the acting force detection device that is shown by the force data received in the step (d), for when the portable information terminal is attached on the weighing apparatus with zero load applied thereto and the weighing apparatus is placed in a second attitude, which differs from the first attitude.

According to further another aspect of the present invention, there is a program that causes a first computer to function as a weighing apparatus in a weighing system for weighing a mass of an object, that is provided with a load receiving device provided for receiving a load, and a load detection device provided for detecting a load acting on the load receiving device, and that causes a second computer to function as a portable information terminal that is attachably and detachably provided on the weighing apparatus, and that is provided with an acting force detection device provided for detecting a force that is acting on the weighing apparatus and that differs from a load acting on the load receiving device. The program causes: the first computer to function as a load output acquisition unit that acquires an output of the load detection device; the second computer to function as a force output acquisition unit that acquires an output of the acting force detection device, and a force data transmission unit that transmits to the weighing apparatus, force data indicating an output acquired by the force output acquisition unit; and the first computer to further function as a force data reception unit that receives the force data transmitted from the portable information terminal, and a correction coefficient calculation unit that calculates, as a correction coefficient for correcting an output of the load detection device, a change amount of an output of the load detection device with respect to a change amount of an output of the acting force detection device based on (i) an output of the load detection device that is acquired by the load output acquisition unit and an output of the acting force detection device that is shown by the force data received by the force data reception unit, for when the portable information terminal is attached on the weighing apparatus with zero load applied thereto and the weighing apparatus is placed in a first attitude and (ii) an output of the load detection device that is acquired by the load output acquisition unit and an output of the acting force detection device that is shown by the force data received by the force data reception unit, for when the portable information terminal is attached on the weighing apparatus with zero load applied thereto and the weighing apparatus is placed in a second attitude, which differs from the first attitude.

According to further another aspect of the present invention, there is a recording medium that records a program that causes a first computer to function as a weighing apparatus in a weighing system for weighing a mass of an object, that is provided with a load receiving device provided for receiving a load, and a load detection device provided for detecting a load acting on the load receiving device, and that causes a second computer to function as a portable information terminal that is attachably and detachably provided on the weighing apparatus, and that is provided with an acting force detection device provided for detecting a force that is acting on the weighing apparatus and that differs from a load acting on the load receiving device. The recording medium records a program that causes: the first computer to further function as a load output acquisition unit that acquires an output of the load detection device; the second computer to function as a force output acquisition unit that acquires an output of the acting force detection device, and a force data transmission unit that transmits to the weighing apparatus, force data indicating an output acquired by the force output acquisition unit; and the first computer to further function as a force data reception unit that receives the force data transmitted from the portable information terminal, and a correction coefficient calculation unit that calculates, as a correction coefficient for correcting an output of the load detection device, a change amount of an output of the load detection device with respect to a change amount of an output of the acting force detection device based on (i) an output of the load detection device that is acquired by the load output acquisition unit and an output of the acting force detection device that is shown by the force data received by the force data reception unit, for when the portable information terminal is attached on the weighing apparatus with zero load applied thereto and the weighing apparatus is placed in a first attitude and (ii) an output of the load detection device that is acquired by the load output acquisition unit and an output of the acting force detection device that is shown by the force data received by the force data reception unit, for when the portable information terminal is attached on the weighing apparatus with zero load applied thereto and the weighing apparatus is placed in a second attitude, which differs from the first attitude.

According to further another aspect of the present invention, there is a weighing method for weighing a mass of an object, the method including: (a) acquiring an output of a load detection device by means of a weighing apparatus that is provided with a load receiving device provided for receiving a load, and the load detection device provided for detecting a load acting on the load receiving device; (b) by means of the weighing apparatus, transmitting load data indicating the output acquired in the step (a) to a portable information terminal that is attachably and detachably provided on the weighing apparatus, and that is provided with an acting force detection device provided for detecting a force that is acting on the weighing apparatus, and that differs from a load acting on the load receiving device; (c) acquiring an output of the acting force detection device by means of the portable information terminal; (d) receiving the load data transmitted from the weighing apparatus, by means of the portable information terminal; and (e) by means of the portable information terminal, calculating, as a correction coefficient for correcting an output of the load detection device, a change amount of an output of the load detection device with respect to a change amount of an output of the acting force detection device based on (i) an output of the load detection device that is shown by the load data received in the step (d) and an output of the acting force detection device that is acquired in the step (c), for when the portable information terminal is attached on the weighing apparatus with zero load applied thereto and the weighing apparatus is placed in a first attitude and (ii) an output of the load detection device that is shown by the load data received in the step (d) and an output of the acting force detection device that is acquired in the step (c), for when the portable information terminal is attached on the weighing apparatus with zero load applied thereto and the weighing apparatus is placed in a second attitude, which differs from the first attitude.

According to further another aspect of the present invention, there is a program that causes a first computer to function as a weighing apparatus in a weighing system for weighing a mass of an object, that is provided with a load receiving device provided for receiving a load, and a load detection device provided for detecting a load acting on the load receiving device, and that causes a second computer to function as a portable information terminal that is attachably and detachably provided on the weighing apparatus, and that is provided with an acting force detection device provided for detecting a force that is acting on the weighing apparatus and that differs from a load acting on the load receiving device. The program causes: the first computer to further function as a load output acquisition unit that acquires an output of the load detection device, and a load data transmission unit that transmits to the portable information terminal, load data indicating the output acquired by the load output acquisition unit; and the second computer to function as a force output acquisition unit that acquires an output of the acting force detection device, a load data reception unit that receives the load data transmitted from the weighing apparatus, and a correction coefficient calculation unit that calculates, as a correction coefficient for correcting an output of the load detection device, a change amount of an output of the load detection device with respect to a change amount of an output of the acting force detection device based on (i) an output of the load detection device that is shown by the load data received by the load data reception unit and an output of the acting force detection device that is acquired by the force output acquisition unit, for when the portable information terminal is attached on the weighing apparatus with zero load applied thereto and the weighing apparatus is placed in a first attitude and (ii) an output of the load detection device that is shown by the load data received by the load data reception unit and an output of the acting force detection device that is acquired by the force output acquisition unit, for when the portable information terminal is attached on the weighing apparatus with zero load applied thereto and the weighing apparatus is placed in a second attitude, which differs from the first attitude.

According to further another aspect of the present invention, there is a recording medium that records a program that causes a first computer to function as a weighing apparatus in a weighing system for weighing a mass of an object, that is provided with a load receiving device provided for receiving a load, and a load detection device provided for detecting a load acting on the load receiving device, and that causes a second computer to function as a portable information terminal that is attachably and detachably provided on the weighing apparatus, and that is provided with an acting force detection device provided for detecting a force that is acting on the weighing apparatus and that differs from a load acting on the load receiving device. The recording medium records a program that causes: the first computer to further function as a load output acquisition unit that acquires an output of the load detection device, and a load data transmission unit that transmits to the portable information terminal, load data indicating the output acquired by the load output acquisition unit; and the second computer to function as a force output acquisition unit that acquires an output of the acting force detection device, a load data reception unit that receives load data transmitted from the weighing apparatus, and a correction coefficient calculation unit that calculates, as a correction coefficient for correcting an output of the load detection device, a change amount of an output of the load detection device with respect to a change amount of an output of the acting force detection device based on (i) an output of the load detection device that is shown by the load data received by the load data reception unit and an output of the acting force detection device that is acquired by the force output acquisition unit, for when the portable information terminal is attached on the weighing apparatus with zero load applied thereto and the weighing apparatus is placed in a first attitude and (ii) an output of the load detection device that is shown by the load data received by the load data reception unit and an output of the acting force detection device that is acquired by the force output acquisition unit, for when the portable information terminal is attached on the weighing apparatus with zero load applied thereto and the weighing apparatus is placed in a second attitude, which differs from the first attitude.

The above summary of the invention does not described all of the characteristics required for the present invention. Moreover, subcombinations of the group of these characteristics may also be the invention.

As can be understood clearly from the above description, according to the present invention, it is possible, for example, to calculate the change amount of the output of the weighing sensor with respect to the change amount of the output of the vibration sensor as a correction coefficient for correcting the output of the weighing sensor, without using a specialized apparatus such as one that applies a standard reference vibration to the scale.

### BRIEF DESCRIPTION OF THE DRAWINGS

FIG. 1 is a diagram showing an example of a structure of a scale according to an embodiment.

FIG. 2 is a diagram showing an example of a hardware configuration of the scale.

FIG. 3 is a diagram showing an example of a block configuration of a processor according to a first embodiment.

FIG. 4 is a diagram showing an example of a flow chart showing the processor according to an embodiment.

FIG. 5 is a diagram showing an example of a flow chart showing the processor according to the first embodiment.

FIG. 6 is a diagram showing an example of a block configuration of the processor according to a second embodiment.

FIG. 7 is a diagram showing an example of a flow chart showing the processor according to the second embodiment.

FIG. 8 is a diagram showing an example of a flow chart showing the processor according to the second embodiment.

FIG. 9 is a diagram showing an example of a block configuration of the processor according to a third embodiment.

FIG. 10 is a diagram showing an example of a flow chart showing the processor according to the third embodiment.

FIG. 11 is a diagram showing an example of a configuration of a weighing system according to an embodiment.

FIG. 12 is a diagram showing an example of a configuration of a weighing system according to an embodiment.

FIG. 13 is a diagram showing an example of a hardware configuration of the scale, which is a constituent of the weighing system.

FIG. 14 is a diagram showing an example of a hardware configuration of a smartphone.

FIG. 15 is a diagram showing an example of a block configuration of a processor according to a fourth embodiment.

FIG. 16 is a diagram showing an example of a block configuration of a processor according to the fourth embodiment.

FIG. 17 is a diagram showing an example of an operation sequence of the scale and the smartphone according to the fourth embodiment.

FIG. 18 is a diagram showing an example of a block configuration of a processor according to a fifth embodiment.

FIG. 19 is a diagram showing an example of a block configuration of a processor according to the fifth embodiment.

FIG. 20 is a diagram showing an example of an operation sequence of a scale and a smartphone according to the fifth embodiment.

### DESCRIPTION OF THE EMBODIMENTS

Hereunder, the present invention is described though embodiments of the invention. However, the following embodiments do not limit the invention of the claims. Furthermore, not all of the combinations of the characteristics described in the embodiments are essential to the problem-solving means of the invention.

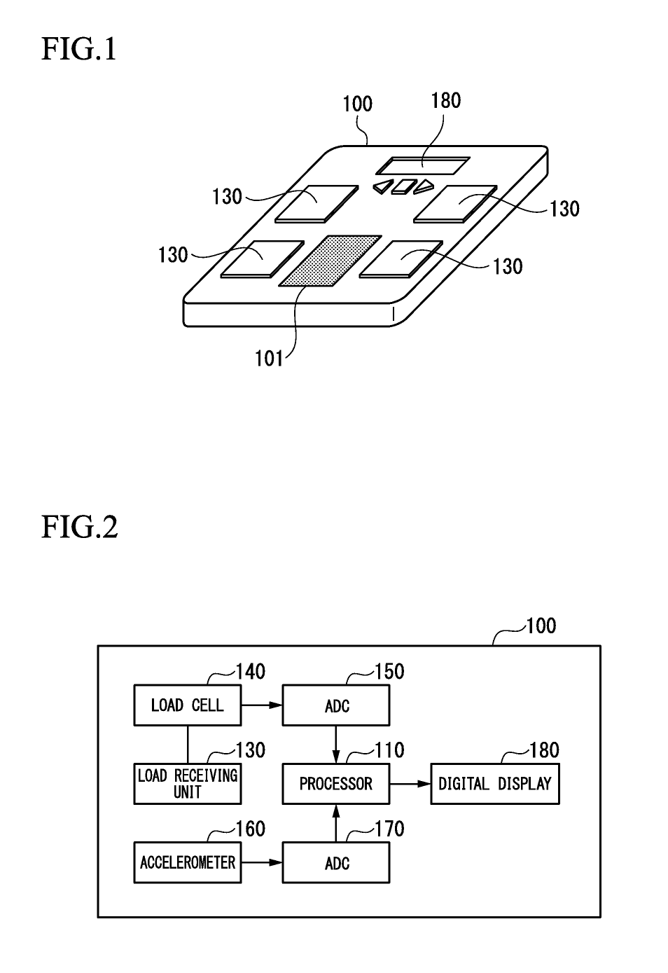

FIG. 1 shows an example of a structure of a scale 100 according to an embodiment. FIG. 2 shows an example of a hardware configuration of the scale 100. The scale 100 is a weighing scale used for weighing the mass of an object (for measuring the mass of an object). The scale 100 may be taken as an example of the “weighing apparatus” or “main body/body” in the present invention.

The scale 100 is provided with a processor 110, a load receiving unit 130, a load cell 140, an ADC (analog-digital converter) 150, an accelerometer 160, an ADC 170, and a digital display 180. In the following description, the function and operation of each constituent are described in detail. The processor 110 may be taken as an example of a “data processing device/data processing section” in the present invention. Moreover, the load receiving unit 130 may be taken as an example of a “load receiving device” in the present invention. Furthermore, the load cell 140 may be taken as an example of a “load detection device” in the present invention. Also, the accelerometer 160 may be taken as an example of an “acting force detection device” in the present invention. The accelerometer 160 can include, for example, an attitude sensor, a G-force sensor, a gravity gradiometry, or the like. Alternatively, another sensor (for example, at least one another load cell, which is different from the load cell 140) can be used as the “acting force detection device.”

The load receiving unit 130 is a portion that is provided for receiving a load. For example, the load receiving unit 130 is provided on the upper surface of the scale (body) 100.

The load cell 140 is a device that converts a load signal detected by a strainmeter (strain gauge) attached on a strain body into a mass to thereby measure a mass. For example, the load cell 140 is provided so that, when the load receiving unit 130 receives a load, a strain body becomes deformed (strained, distorted) due to the load. Moreover, the load cell 140 is electrically connected to the ADC 150. Upon measuring a mass, the load cell 140 outputs an analog signal that indicates the measurement result to the ADC 150. A mass measurement may be taken as an example of “load detection” in the present invention.

The ADC 150 is a circuit that converts an analog signal into a digital signal. For example, the ADC 150 is electrically connected to the load cell 140 and the processor 110. Upon receiving an input of an analog signal output from the load cell 140, the ADC 150 converts the analog signal into a digital signal, and outputs the digital signal to the processor 110.

The accelerometer 160 is a sensor that measures an acceleration. For example, the accelerometer 160 is electrically connected to the ADC 170. Upon measuring an acceleration, the accelerometer 160 outputs an analog signal that indicates the measurement result to the ADC 170. An acceleration (e.g., G-forces, acceleration of gravity, static acceleration, proper acceleration) may be taken as an example of a “force that is acting on the weighing apparatus, and that differs from the load acting on the load receiving device” in the present invention. Moreover, an acceleration measurement may be taken as an example of “force detection” in the present invention.

The ADC 170 is a circuit that converts an analog signal into a digital signal. For example, the ADC 170 is electrically connected to the accelerometer 160 and the processor 110. Upon receiving an input of an analog signal output from the accelerometer 160, the ADC 170 converts the analog signal into a digital signal, and outputs the digital signal to the processor 110.

The processor 110 is an electronic device that processes the converted data of the output signal of the load cell 140 as a weighed value in mass units, based on the digital data output from the ADC 150 and the ADC 170. For example, the processor 110 is electrically connected to the ADC 150, the ADC 170, and the digital display 180. The processor 110 outputs a signal indicating the process result to the digital display 180.

The digital display 180 is a device that determines high and low of a signal voltage, and controls every single pixel to display on a screen. For example, the digital display 180 is electrically connected to the processor 110. The digital display 180 performs screen display based on electric signals output from the processor 110.

In the present embodiment, with the purpose of preventing the description from becoming complicated, there is described a configuration such that the scale 100 is provided with a processor 110, a load receiving unit 130, a load cell 140, an ADC 150, an accelerometer 160, an ADC 170, and a digital display 180. Alternatively, the scale 100 may be provided with a plurality of processors 110, load receiving units 130, load cells 140, ADCs 150, accelerometers 160, ADCs 170, and digital displays 180.

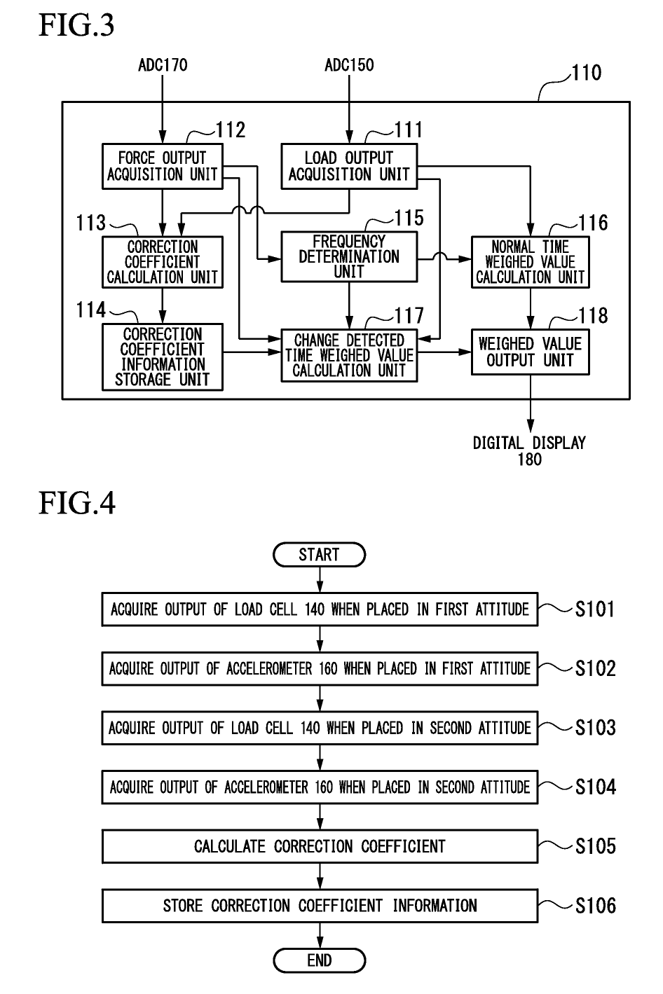

FIG. 3 shows an example of a block configuration of the processor 110 according to the first embodiment. The processor 110 according to the present embodiment has a load output acquisition unit 111, a force output acquisition unit 112, a correction coefficient calculation unit 113, a correction coefficient information storage unit 114, a frequency determination unit 115, a normal time weighed value calculation unit 116, a change detected time weighed value calculation unit 117, and a weighed value output unit 118. In the following description, the function and operation of each constituent are described in detail.

The load output acquisition unit 111 acquires an output of the load cell 140.

The force output acquisition unit 112 acquires an output of the accelerometer 160.

The correction coefficient calculation unit 113 treats a change amount of an output of the load cell 140 with respect to a change amount of an output of the accelerometer 160, as a correction coefficient for correcting an output of the load cell 140, based on: outputs of the load cell 140 and the accelerometer 160 acquired respectively by the load output acquisition unit 111 and the force output acquisition unit 112, for when the scale 100 with zero load applied thereto is placed in a first attitude; and outputs of the load cell 140 and the accelerometer 160 acquired respectively by the load output acquisition unit 111 and the force output acquisition unit 112, for when the scale 100 with zero load applied thereto is placed in a second attitude. Here, “with zero load applied thereto” refers to “a state where no object to be weighed is placed on the load receiving unit 130”. The first attitude or the second attitude can include, for example, a horizontal attitude, a vertical attitude, an inclined attitude, or a reversed attitude.

In other words, the correction coefficient calculation unit 113 obtains a first output of the load cell 140 acquired by the load output acquisition unit 111 and a second output of the accelerometer 160 acquired by the force output acquisition unit 112, for when the scale 100 with zero load applied thereto is placed in a first attitude, obtains a third output of the load cell 140 acquired by the load output acquisition unit 111 and a fourth output of the accelerometer 160 acquired by the force output acquisition unit 112, for when the scale 100 with zero load applied thereto is placed in a second attitude, which differs from the first attitude, and treats a difference between the third output and the first output (a change amount of an output of the load cell 140) relative to a difference between the fourth output and the second output (a change amount of an output of the accelerometer 160), as a correction coefficient for correcting an output of the load cell 140.

The correction coefficient information storage unit 114 stores information of correction coefficients calculated by the correction coefficient calculation unit 113.

The frequency determination unit 115 determines, in a case where a change occurs in the output of the accelerometer 160 at the time of weighing, whether or not the frequency of this change is smaller than a threshold value.

The normal time weighed value calculation unit 116 takes the output value of the load cell 140 as a weighed value.

The change detected time weighed value calculation unit 117, in a case where the frequency determination unit 115 determines the frequency as being smaller than the threshold value, treats a value that is calculated by subtracting, from the output value of the load cell 140, the value obtained by multiplying the output value of the accelerometer 160 by the correction coefficient calculated by the correction coefficient calculation unit 113, as a weighed value.

The weighed value output unit 118 outputs a signal for displaying a weighed value to the digital display 180.

FIG. 4 shows an example of a flow chart showing the processor 110 according to an embodiment. In the description of this flowchart, a process of setting a correction coefficient is described in detail. This operation is described, with reference to FIG. 1 through FIG. 3.

When setting a correction coefficient, the operator that operates the scale 100 switches the operation mode of the scale 100, for example, to a mode for setting a correction coefficient. The operator then places the scale 100 with zero load applied thereto in the first attitude, and, for example, performs a predetermined first operation to make the processor 110 recognize the scale 100 as having been placed in the first attitude. As the first attitude, the operator places the scale 100 so that the load receiving unit 130 is positioned on the upper side for example. As the predetermined first operation, the operator then presses a button provided for making the processor 110 recognize the scale 100 as having been placed in the first attitude for example.

Once the predetermined first operation has been performed, the load output acquisition unit 111 of the processor 110 acquires an output of the load cell 140 (S101). For example, the load output acquisition unit 111 samples a digital signal output from the ADC 150 at the timing at which the predetermined first operation is performed, to thereby acquire an output of the load cell 140. If the digital display 180 is set to display the weighed value at zero in the state where the scale 100 with zero load applied thereto is placed with the load receiving unit 130 turned up, the load cell 140 measures a value of zero. The load output acquisition unit 111 then outputs to the correction coefficient calculation unit 113, the first load data indicating the acquired output value.

On the other hand, once the predetermined first operation has been performed, the force output acquisition unit 112 of the processor 110 acquires an output of the accelerometer 160 (S102). For example, the force output acquisition unit 112 samples a digital signal output from the ADC 170 at the timing at which the predetermined first operation is performed, to thereby acquire an output of the accelerometer 160. The accelerometer 160 measures the value of a gravitational acceleration. The force output acquisition unit 112 then outputs to the correction coefficient calculation unit 113, the first force data indicating the acquired output value.

Next, the operator places the scale 100 with zero load applied thereto in the second attitude, and, for example, performs a predetermined second operation to make the processor 110 recognize the scale 100 as having been placed in the second attitude. As the second attitude, the operator places the scale 100 with the load receiving unit 130 turned down for example. As the predetermined second operation, the operator then presses a button provided for making the processor 110 recognize the scale 100 as having been placed in the second attitude for example.

Once the predetermined second operation has been performed, the load output acquisition unit 111 of the processor 110 acquires an output of the load cell 140 (S103). For example, the load output acquisition unit 111 samples a digital signal output from the ADC 150 at the timing at which the predetermined second operation is performed, to thereby acquire an output of the load cell 140. If the digital display 180 is set to display the weighed value at zero in the state where the scale 100 with zero load applied thereto is placed in the manner with the load receiving unit 130 turned up, the load cell 140 measures a value that includes the weight of the load cell 140, the weight of part of the casing of the scale 100, and the like. The load output acquisition unit 111 then outputs to the correction coefficient calculation unit 113, the second load data indicating the acquired output value.

On the other hand, once the predetermined second operation has been performed, the force output acquisition unit 112 of the processor 110 acquires an output of the accelerometer 160 (S104). For example, the force output acquisition unit 112 samples a digital signal output from the ADC 170 at the timing at which the predetermined second operation is performed, to thereby acquire an output of the accelerometer 160. The accelerometer 160 measures the value of a gravitational acceleration in a direction opposite of that in the case where the scale 100 is placed in the manner with the load receiving unit 130 turned up. The force output acquisition unit 112 then outputs to the correction coefficient calculation unit 113, the second force data indicating the acquired output value.

Upon receiving the first load data, the first force data, the second load data, and the second force data respectively, the correction coefficient calculation unit 113 of the processor 110 treats the change amount of the output of the load cell 140 with respect to the change amount of the output of the accelerometer 160 as a correction coefficient for correcting the output of the load cell 140, based on these data (S105). For example, where the output value of the load cell 140 indicated by the first load data is taken as SG1, the output value of the accelerometer 160 indicated by the first force data is taken as ACC1, the output value of the load cell 140 indicated by the second load data is taken as SG2, and the output value of the accelerometer 160 indicated by the second force data is taken as ACC2, the correction coefficient calculation unit 113 calculates a correction coefficient CC in the manner expressed by Equation (1).

[Equation 1]

CC=(SG2−SG1)/(ACC2−ACC1) (1)

The correction coefficient calculation unit 113 stores information indicating the calculated correction coefficient into the correction coefficient information storage unit 114 (S106). In this manner, a correction coefficient is set in the scale 100.

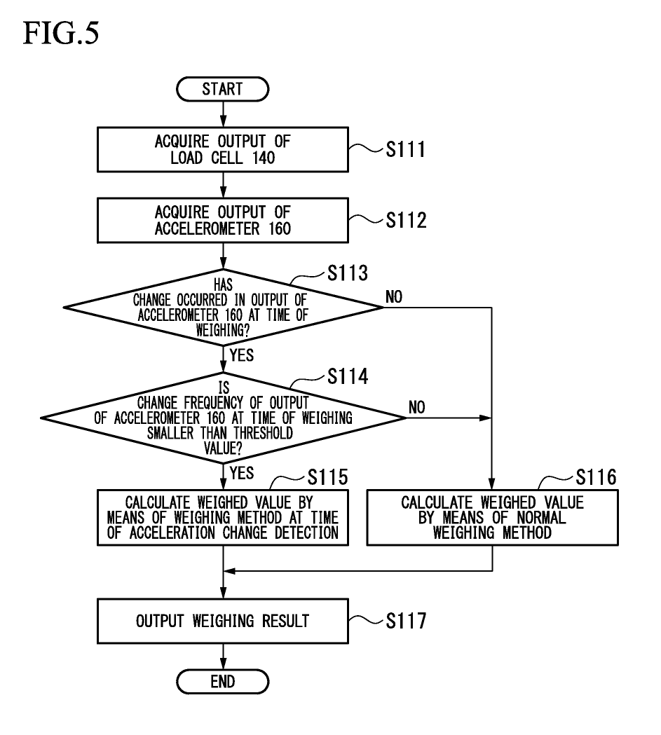

FIG. 5 shows an example of an operation flow of the processor 110 according to the first embodiment. In this operation flow, there is described in detail a process in the case where low frequency vibration is applied to the scale 100 at the time of weighing. This operation flow is described, with reference to FIG. 1 through FIG. 4.

When weighing, the user of the scale 100 switches the operation mode of the scale 100, for example, to a weighing mode for performing weighing. The user then places an object to be weighed on the load receiving unit 130 of the scale 100.

When the object to be weighed is placed on the load receiving unit 130 of the scale 100, the load output acquisition unit 111 of the processor 110 acquires an output of the load cell 140 (S111). For example, the load output acquisition unit 111 repeatedly samples digital signals output from the ADC 150 for a predetermined period of time from the moment the object to be weighed was placed on the load receiving unit 130 of the scale 100, to thereby acquire an output of the load cell 140. At each time when the output of the load cell 140 is acquired, the load output acquisition unit 111 outputs, to the normal time weighed value calculation unit 116 and the change detected time weighed value calculation unit 117, the load data indicating the acquired output value.

On the other hand, when the object to be weighed is placed on the load receiving unit 130 of the scale 100, the force output acquisition unit 112 of the processor 110 acquires an output of the accelerometer 160 (S112). For example, the force output acquisition unit 112 repeatedly samples digital signals output from the ADC 170 for a predetermined period of time from the moment the object to be weighed was placed on the load receiving unit 130 of the scale 100, to thereby acquire an output of the accelerometer 160. At each time when the output of the accelerometer 160 is acquired, the force output acquisition unit 112 outputs, to the frequency determination unit 115 and the change detected time weighed value calculation unit 117, the force data indicating the acquired output value.

Upon receiving a plurality of force data from the force output acquisition unit 112, the frequency determination unit 115 of the processor 110 determines whether or not any change has occurred in the output of the accelerometer 160 indicated by each of the force data (S113). For example, if vibration is applied to the scale 100, a change occurs in the output of the accelerometer 160.

The frequency determination unit 115 then determines, in a case where a change is determined as occurring in the output of the accelerometer 160 (S113: YES), whether or not the frequency of this change is smaller than a threshold value (S114). For example, the threshold value is set to a value for detecting low frequency vibration, the removal of which by means of a filtering process is not appropriate. Therefore, if this type of low frequency vibration is applied to the scale 100, the frequency determination unit 115 determines the frequency as being smaller than the threshold value. If the frequency is determined as being smaller than the threshold value (S114: YES), the frequency determination unit 115 then transmits, to the change detected time weighed value calculation unit 117, notification data that notifies of the determination result.

The change detected time weighed value calculation unit 117 of the processor 110 receives load data from the load output acquisition unit 111, and receives force data from the force output acquisition unit 112. Upon receiving the notification data from the frequency determination unit 115, the change detected time weighed value calculation unit 117 calculates a weighed value based on; the output value of the load cell 140 indicated by the load data, the output value of the accelerometer 160 indicated by the force data, and the correction coefficient stored in the correction coefficient information storage unit 114 (S115). For example, where the output value of the load cell 140 is taken as SG, the output value of the accelerometer 160 is taken as ACC, and the correction coefficient is taken as CC, the change detected time weighed value calculation unit 117 calculates a weighed value CCSG in the manner expressed by Equation (2).

[Equation 2]

CCSG=SG−CC×ACC (2)

The change detected time weighed value calculation unit 117 then transmits the weighed value data indicating the calculated weighed value to the weighed value output unit 118.

Upon receiving the weighed value data from the change detected time weighed value calculation unit 117, the weighed value output unit 118 of the processor 110 outputs a signal for displaying the weighed value indicated by the weighed value data (S117) to the digital display 180. In this manner, even if the scale 100 received low frequency vibration, the digital display 180 displays the weighed value, for which the influence of this vibration has been compensated.

On the other hand, if no change is determined in step S113 as occurring in the output of the accelerometer 160 (S113: NO), the frequency determination unit 115 then transmits, to the normal time weighed value calculation unit 116, notification data that notifies of the determination result. Moreover, if the frequency is determined in step S114 as not being smaller than the threshold value (S114: NO), the frequency determination unit 115 then transmits, to the normal time weighed value calculation unit 116, notification data that notifies of the determination result.

Upon receiving the notification data from the frequency determination unit 115, the normal time weighed value calculation unit 116 of the processor 110 takes an output value of the load cell 140 as a weighed value (S116). The normal time weighed value calculation unit 116 then transmits the weighed value data indicating the calculated weighed value to the weighed value output unit 118.

Upon receiving the weighed value data from the normal time weighed value calculation unit 116, the weighed value output unit 118 of the processor 110 outputs a signal for displaying the weighed value indicated by the weighed value data (S117) to the digital display 180. In this manner, the digital display 180 displays the weighed value.

As described above, the scale 100 weighs the mass of an object. The scale 100 is provided with a load receiving unit 130 that is provided for receiving a load. Moreover, the scale 100 is provided with a load cell 140 that is provided for detecting a load acting on the load receiving unit 130. Furthermore, the scale 100 is provided with an accelerometer 160 that is provided for detecting an acceleration. Moreover, the scale 100 is provided with a processor 110 that data-processes the output of the load cell 140 as a weighed value in mass units. The processor 110 acquires an output of the load cell 140. Moreover, the processor 110 acquires an output of the accelerometer 160. The processor 110 treats a change amount of an output of the load cell 140 with respect to a change amount of an output of the accelerometer 160, as a correction coefficient for correcting an output of the load cell 140, based on: outputs of the load cell 140 and the accelerometer 160 acquired when the scale 100 with zero load applied thereto is placed in a first attitude; and outputs of the load cell 140 and the accelerometer 160 acquired when the scale 100 with zero load applied thereto is placed in a second attitude, which differs from the first attitude.

In this manner, according to the scale 100, it is possible to calculate the change amount of the output of the load cell 140 with respect to the change amount of the output of the accelerometer 160 as a correction coefficient for correcting the output of the load cell 140, without using a specialized apparatus such as one that applies a standard reference vibration to the scale 100.

Moreover, as described above, the scale 100 according to the present embodiment determines, in a case where a change occurs in the output of the accelerometer 160 at the time of weighing, whether or not the frequency of this change is smaller than a threshold value. The scale 100, in a case where the frequency is determined as being smaller than the threshold value, treats a value that is calculated by subtracting, from the output value of the load cell 140, the value obtained by multiplying the output value of the accelerometer 160 by the correction coefficient, as a weighed value.

In this manner, according to the scale 100 of the present embodiment, even if the scale 100 received low frequency vibration, it is possible to calculate a weighed value, for which the influence of this vibration has been compensated.

Incidentally, there are some scales that are provided with a function that enables weighing without the need for setting the display to zero during the period between the moment when the power is turned on and the moment of use. A scale that has this type of function performs on a periodic basis a process of automatically setting the display to zero without intervention of an operator when zero load is applied thereto, and when a load is detected, the scale calculates a weighed value on the basis of zero point for at the point in time. Therefore, the scale always needs to be stored in the same horizontal position as that at the time of weighing, so that the display is set to zero in the same horizontal position as that at the time of weighing. However, a scale is often stored by leaning against a wall due to issues of available storage space or the like. If the scale has not been stored in a horizontal position, a precise weighed value cannot be obtained unless the user places the scale in a horizontal position at the time of weighing and performs the process of setting the display to zero, and then starts weighing. In the following description, there is described in detail a scale 100 that is provided with a processor 110 according to a second embodiment, and that can solve this type of problem also.

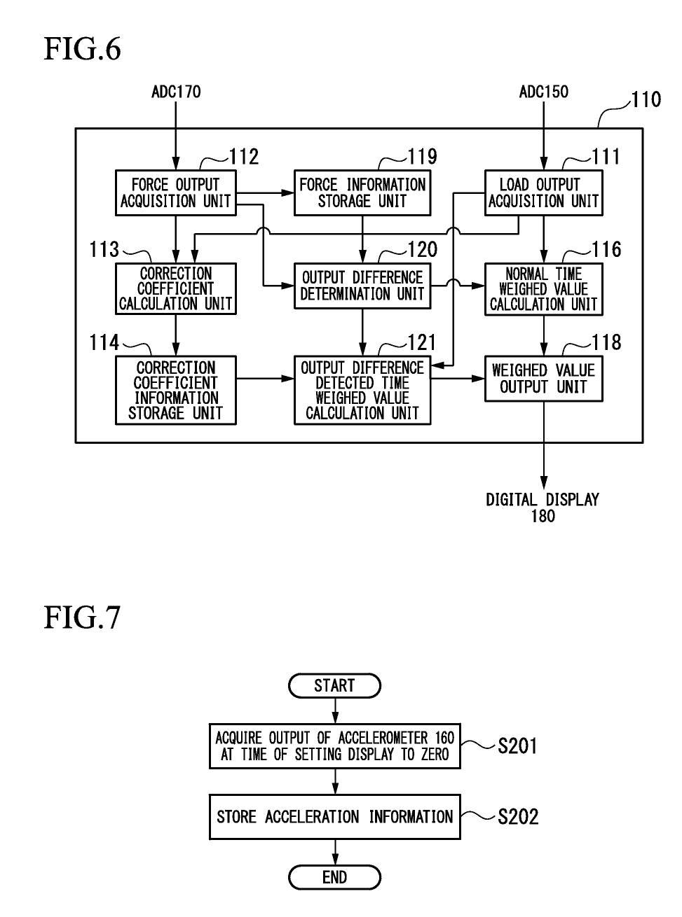

FIG. 6 shows an example of a block configuration of the processor 110 according to the second embodiment. The processor 110 according to the present embodiment has a load output acquisition unit 111, a force output acquisition unit 112, a correction coefficient calculation unit 113, a correction coefficient information storage unit 114, a force information storage unit 119, an output difference determination unit 120, a normal time weighed value calculation unit 116, an output difference detected time weighed value calculation unit 121, and a weighed value output unit 118. In the following description, the function and operation of each constituent are described in detail.

The constituents of the same names with the same reference symbols among the constituents of the processor 110 of the previously described embodiment, and the processor 110 of the present embodiment, exhibit similar functions and operations.

When the display is automatically set to zero without intervention of an operator, the force information storage unit 119 stores information of the gravitational acceleration measured by the accelerometer 160.

The output difference determination unit 120 determines whether or not the output difference between the output of the accelerometer 160 when the display is automatically set to zero without intervention of an operator, and the output of the accelerometer 160 at the time of weighing, is within an acceptable value.

The output difference detected time weighed value calculation unit 121, in a case where the output difference determination unit 120 determines the output difference as not being within the acceptable value, treats a value that is calculated by subtracting, from the output value of the load cell 140, the value obtained by multiplying the output difference value by a correction coefficient calculated by the correction coefficient calculation unit 113, as a weighed value.

FIG. 7 shows an example of an operation flow of the processor 110 according to the second embodiment. In the description of this flow chart, there is described in detail a process performed when the display is automatically set to zero without intervention of an operator. This flow chart is described, with reference to FIG. 1 through FIG. 6.

In order to realize a function of enabling weighing without the need for setting the display to zero after the power is turned on and before use, the scale 100 performs on a periodic basis a process of automatically setting the display to zero without intervention of an operator when zero load is applied thereto.

If the display is automatically set to zero without operator intervention when zero load is applied, the force output acquisition unit 112 of the processor 110 acquires an output of the accelerometer 160 (S201). For example, the force output acquisition unit 112 samples a digital signal output from the ADC 170 at the timing at which the display is automatically set to zero without operator intervention when zero load is applied, to thereby acquire an output of the accelerometer 160. For example, in a case where the scale 100 is not placed horizontally and the display thereof is set to zero in a state of leaning against a wall, the accelerometer 160 measures a gravitational acceleration in a direction different from that of the gravitational velocity in the case of the scale 100 being placed horizontally. Then the force output acquisition unit 112 acquires a gravitational acceleration value measured by the accelerometer 160. The force output acquisition unit 112 then stores the information of the acquired gravitational acceleration into the force information storage unit 119 (S202). In this manner, the scale 100 stores information of the gravitational acceleration at the time of setting the display automatically to zero without operator intervention when zero load is applied.

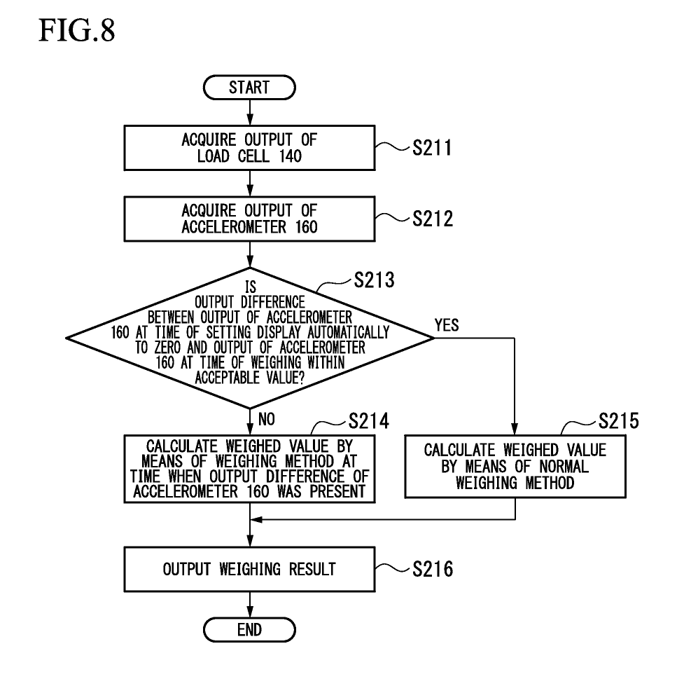

FIG. 8 shows an example of a flow chart of the processor 110 according to the second embodiment. In the description of this flow chart, there is described a process in the case where the attitude of the scale 100 with zero load applied thereto at the time of having the display automatically set to zero without operator intervention differs from the attitude of the scale 100 at the time of weighing. This flow chart is described, with reference to FIG. 1 through FIG. 7.

In the case of using the function that enables weighing without the need for setting the display to zero after the power is turned on and before use, the user of the scale 100 places an object to be weighed on the load receiving unit 130 of the scale 100 immediately after the power is turned on.

When the object to be weighed is placed on the load receiving unit 130 of the scale 100, the load output acquisition unit 111 of the processor 110 acquires an output of the load cell 140 (S211). For example, the load output acquisition unit 111 samples a digital signal output from the ADC 150 at the timing at which the object to be weighed is placed on the load receiving unit 130 of the scale 100, to thereby acquire an output of the load cell 140. The load output acquisition unit 111 then outputs, to the normal time weighed value calculation unit 116 and the output difference detected time weighed value calculation unit 121, the load data indicating the acquired output value.

On the other hand, when the object to be weighed is placed on the load receiving unit 130 of the scale 100, the force output acquisition unit 112 of the processor 110 acquires an output of the accelerometer 160 (S212). For example, the force output acquisition unit 112 samples a digital signal output from the ADC 170 at the timing at which the object to be weighed is placed on the load receiving unit 130 of the scale 100, to thereby acquire an output of the accelerometer 160. For example, in a case where the scale 100 is placed horizontally at the time of weighing, the accelerometer 160 measures a gravitational acceleration in the case of the scale 100 being placed horizontally. Then the force output acquisition unit 112 acquires a gravitational acceleration value measured by the accelerometer 160. The force output acquisition unit 112 then outputs to the output difference determination unit 120, the force data indicating the acquired output value.

Upon receiving the force data from the force output acquisition unit 112, the output difference determination unit 120 of the processor 110 determines whether or not the difference between the gravitational acceleration value indicated by each of the force data and the gravitational acceleration value stored in the force information storage unit 119, is within the acceptable value (S213). For example, in the case where the scale 100 is not placed horizontally when the display is automatically set to zero without operator intervention while zero load is applied, an output difference occurs in the output of the accelerometer 160. The acceptable value with respect to this output difference is, for example, set to a value so that the attitude at the time when the display is automatically set to zero without operator intervention while zero load is applied, is determined as being an attitude acceptable with respect to the horizontal attitude. Therefore, in the case where the display is set to zero while the scale 100 is placed in this type of acceptable attitude, the output difference determination unit 120 determines the output difference as being within the acceptable value. If the output difference is determined as not being within the acceptable value (S213: NO), the output difference determination unit 120 transmits the output difference data indicating the output difference, to the output difference detected time weighed value calculation unit 121.

The output difference detected time weighed value calculation unit 121 of the processor 110 receives load data from the load output acquisition unit 111. Upon receiving the output difference data from the output difference determination unit 120, the output difference detected time weighed value calculation unit 121 calculates a weighed value, based on; the output difference value of the accelerometer 160 indicated by the output difference data, the output value of the load cell 140 indicated by the load data, and the correction coefficient stored in the correction coefficient information storage unit 114 (S214).

For example, where the output value of the load cell 140 is taken as SG, the correction coefficient is taken as CC, and the output difference value is taken as ACC0, the output difference detected time weighed value calculation unit 121 calculates a weighed value CCSG in the manner expressed by Equation (3).

[Equation 3]

CCSG=SG−CC×ACC0 (3)

The output difference detected time weighed value calculation unit 121 then transmits the weighed value data indicating the calculated weighed value to the weighed value output unit 118.

Upon receiving the weighed value data from the output difference detected time weighed value calculation unit 121, the weighed value output unit 118 of the processor 110 outputs a signal for displaying the weighed value indicated by the weighed value data (S216) to the digital display 180. In this manner, even if the attitude of the scale 100 at the time when the display is automatically set to zero without operator intervention while zero load is applied, differs from the attitude of the scale 100 at the time of weighing, the digital display 180 displays a weighed value, for which the influence of the attitude difference has been compensated.

On the other hand, if the output difference is determined in step S213 as being within the acceptable value (S213: NO), the output difference determination unit 120 then transmits, to the normal time weighed value calculation unit 116, notification data that notifies of the determination result.

Upon receiving the notification data from the output difference determination unit 120, the normal time weighed value calculation unit 116 of the processor 110 takes the output value of the load cell 140 as a weighed value (S215). The normal time weighed value calculation unit 116 then transmits the weighed value data indicating the calculated weighed value to the weighed value output unit 118.

Upon receiving the weighed value data from the normal time weighed value calculation unit 116, the weighed value output unit 118 of the processor 110 outputs a signal for displaying the weighed value indicated by the weighed value data (S216) to the digital display 180. In this manner, the digital display 180 displays the weighed value.

As described above, the scale 100 according to the present embodiment determines whether or not the output difference between the output of the accelerometer 160 when the display is automatically set to zero without intervention of an operator, and the output of the accelerometer 160 at the time of weighing, is within an acceptable value. The scale 100, in a case where the output difference is determined as not being within the acceptable value, treats a value that is calculated by subtracting, from the output value of the load cell 140, the value obtained by multiplying the output difference value by the correction coefficient, as a weighed value.

In this manner, according to the scale 100 of the present embodiment, even if the attitude of the scale 100 at the time when the display is automatically set to zero without operator intervention while zero load is applied, differs from the attitude of the scale 100 at the time of weighing, it is possible to calculate a weighed value, for which the influence of the attitude difference has been compensated.

Incidentally, the span coefficient of the load cell may change for various reasons. For example, the span coefficient of the load cell changes due to changes occurring in the strain body across the ages. Moreover, for example, the span coefficient of the load cell changes as a result of the scale being used beyond the predetermined durability. Furthermore, the span coefficient of the load cell changes as a result of an unexpected load being applied, for example, when the scale is dropped. Normally, the span coefficient is adjusted by mounting a weight of the weighing capacity. However, this type of adjustment method is difficult for general users. In the following description, there is described in detail a scale 100 that is provided with a processor 110 according to a third embodiment, and that can solve this type of problem also.

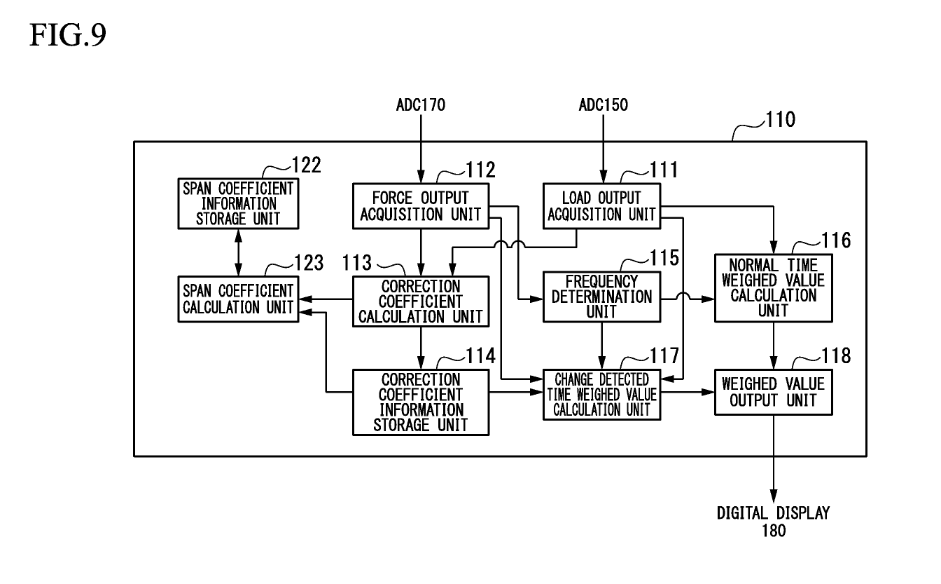

FIG. 9 shows an example of a block configuration of a processor 110 according to the third embodiment. The processor 110 according to the present embodiment has a load output acquisition unit 111, a force output acquisition unit 112, a correction coefficient calculation unit 113, a correction coefficient information storage unit 114, a frequency determination unit 115, a normal time weighed value calculation unit 116, a change detected time weighed value calculation unit 117, a weighed value output unit 118, a span coefficient information storage unit 122, and a span coefficient calculation unit 123. In the following description, the function and operation of each constituent are described in detail.

The constituents of the same names with the same reference symbols among the constituents of the processor 110 of the previously described embodiments, and the processor 110 of the present embodiment, exhibit similar functions and operations.

The span coefficient information storage unit 122 stores span coefficient information of the load cell 140. Here, a span coefficient is a coefficient value that associates an output of the load cell 140 and a weight value. When calculating a weighed value, the output value of the load cell 140 is multiplied by a span coefficient.

The span coefficient calculation unit 123 treats, as a span coefficient of the load cell 140 after shipment, a value that is calculated by multiplying a value obtained by dividing a correction coefficient calculated after shipment by the correction coefficient calculation unit 113 by a correction coefficient calculated before shipment by the correction coefficient calculation unit 113, by the span coefficient of the load cell 140 obtained before shipment.

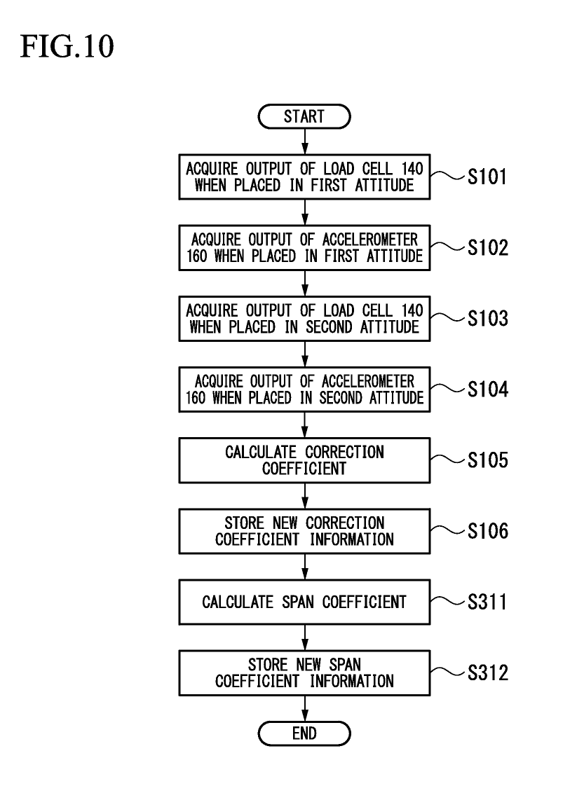

FIG. 10 shows an example of an operation flow of the processor 110 according to the third embodiment. In the description of this operation flow, there is described in detail a process in the case of adjusting the span coefficient of the load cell 140 after shipment. This operation flow is described, with reference to FIG. 1 through FIG. 9.

In the following description, the correction coefficient information storage unit 114 stores information of the correction coefficient calculated before shipment. Moreover, the span coefficient information storage unit 122 stores information of the span coefficient calculated before shipment.

When adjusting the span coefficient after shipment, the user of the scale 100 switches the operation mode of the scale 100, for example, to a mode for adjusting the span coefficient. The user then performs an operation for calculating a correction coefficient. When this type of operation has been performed, the processor 110 performs processes similar to those in step S101 through step S106 of FIG. 4. In this manner, the correction coefficient information storage unit 114 stores information of correction coefficients calculated after shipment, along with the information of the correction coefficient calculated before shipment.

When the information of the correction coefficient after shipment has been calculated, the span coefficient calculation unit 123 of the processor 110 calculates a span coefficient of the load cell 140, based on; the correction coefficient that is stored in the correction coefficient information storage unit 114 and that is calculated before shipment, the correction coefficient calculated after shipment, and the span coefficient that is stored in the span coefficient information storage unit 122 and that is obtained before shipment (S311).

For example, where the correction coefficient calculated before shipment is taken as CC1, the correction coefficient calculated after shipment is taken as CC2, and the span coefficient obtained before shipment is taken as SC1, the span coefficient calculation unit 123 calculates a current span coefficient SC2 after shipment in the manner expressed by Equation (4).

[Equation 4]

SC2=SC1×(CC2/CC1) (4)

Then, the span coefficient calculation unit 123 stores information indicating the calculated span coefficient into the span coefficient information storage unit 122 (S312). In this manner, the span coefficient information storage unit 122 stores information of the span coefficient obtained before shipment and the information of the span coefficient obtained after shipment.

When calculating a weighed value subsequently, the processor 110 makes reference to the information of the newly calculated correction coefficient and the information of the span coefficient.

As described above, the scale 100 according to the present embodiment treats, as a span coefficient of the load cell 140 after shipment, a value that is calculated by multiplying a value obtained by dividing a correction coefficient calculated after shipment by a correction coefficient calculated before shipment, by the span coefficient of the load cell 140 obtained before shipment.

In this manner, according to the scale 100 of the present embodiment, even if the span coefficient changes after shipment, the span coefficient can be adjusted by means of a simple method that can be performed by general users.

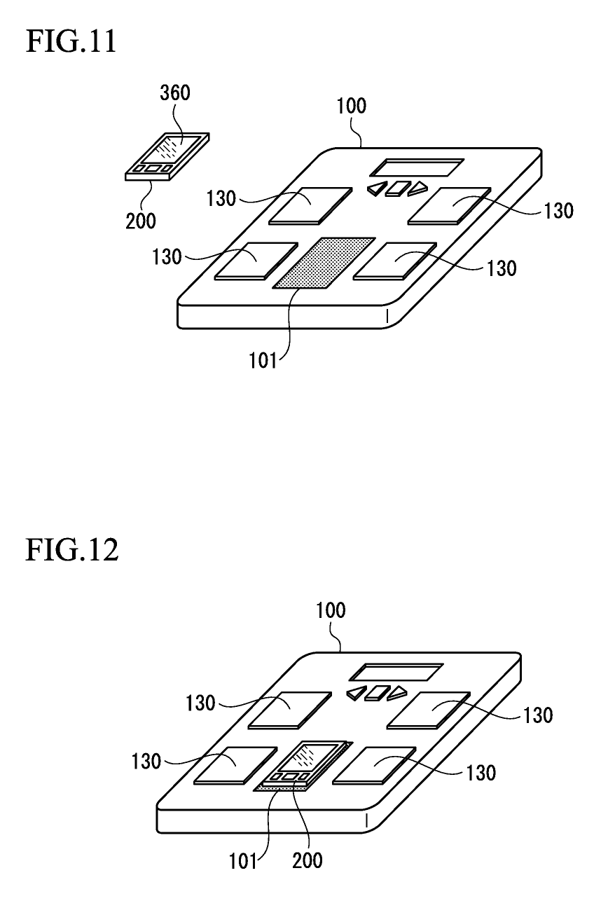

FIG. 11 and FIG. 12 show an example of a configuration of a weighing system according to an embodiment. The weighing system according to the present embodiment is a system to be used for weighing the mass of an object.

The weighing system according to the present embodiment is provided with a scale 100 and a smartphone 200.

Here, the smartphone 200 is a mobile phone that also has a personal portable computer function. The smartphone 200 may be taken as an example of a “another body/portable information terminal (mobile terminal, personal digital assistant)” in the present invention.

On the upper surface of the scale 100, there is provided an attachment unit 101 on which the smartphone 200 is attached. The smartphone 200 is attached on and/or detached from the attachment unit 101 of the scale 100. FIG. 11 shows a state where the smartphone 200 has been removed from the attachment unit 101 of the scale 100. FIG. 12 shows a state where the smartphone 200 is attached on the attachment unit 101 of the scale 100.

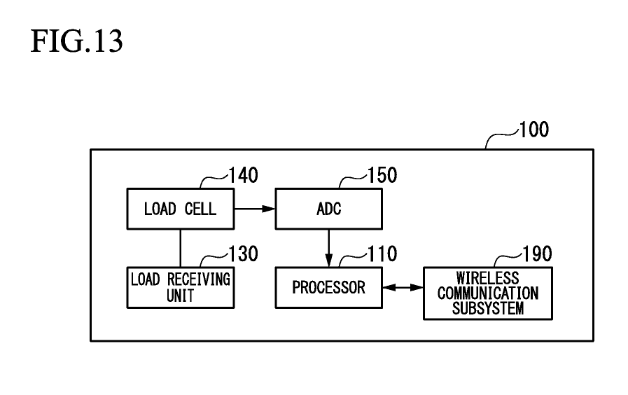

FIG. 13 shows an example of a hardware configuration of the scale 100, which is a constituent of the weighing system. The scale 100, which is a constituent of the weighing system, is provided with a processor 110, a load receiving unit 130, a load cell 140, an ADC 150, and a wireless communication subsystem 190.

The constituents of the same names with the same reference symbols among the constituents of the scale 100 of the previously described embodiments, and the scale 100 of the present embodiment, exhibit similar functions and operations.

The communication function of the scale 100 may be subserved through one or more wireless communication subsystems 190 that can include a wireless frequency receiver and transmitter, and/or an optical receiver and transmitter. The specific design and implementation of the wireless communication subsystem 190 may depend on a communication network through which the scale 100 operates. For example, the scale 100 can include a wireless communication subsystem 190 that is designed to operate through a GSM (global system for mobile communications) (registered trademark) network, a GPRS (general packet radio service) network, an EDGE (enhanced data GSM environment) network, a Wi-Fi (wireless fidelity) network, and/or a Bluetooth (registered trademark) network.

In particular, the wireless communication subsystem 190 can include a hosting protocol that enables a configuration in which the scale 100 serves as a base station for the smartphone 200.

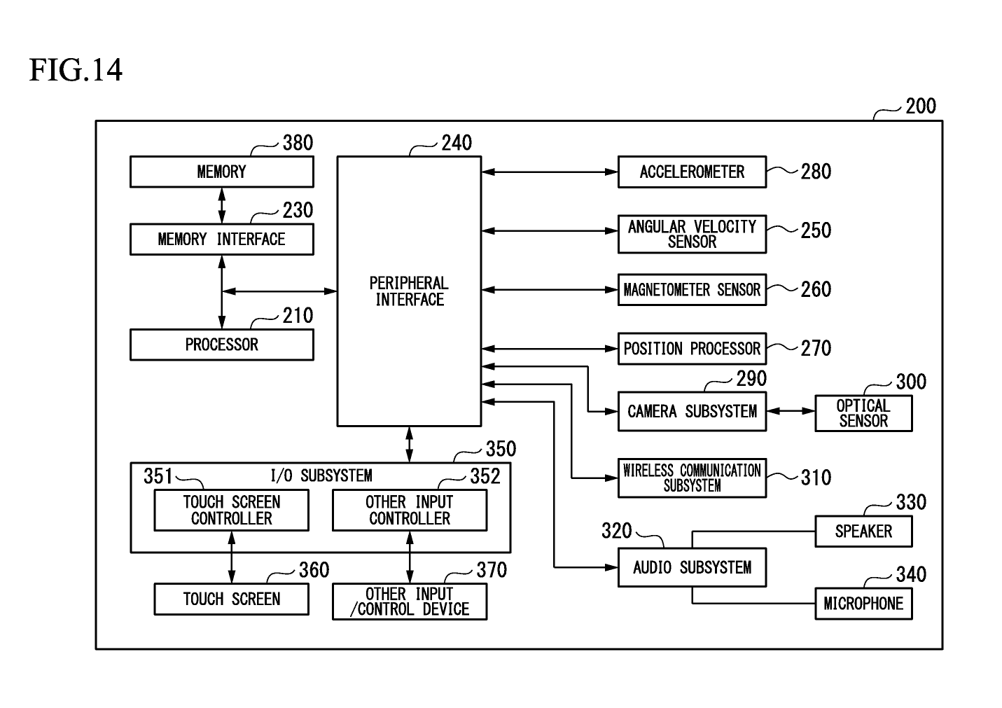

FIG. 14 shows an example of a hardware configuration of the smartphone 200. The smartphone 200 can include a memory interface 230, one or more data processors, image processors, and/or processors 210, and a peripheral interface 240. The memory interface 230, one or more of the processors 210, and/or the peripheral interface 240 may be individual components, or may be integrated on one or more integrated circuits. Various constituents of the smartphone 200 may be connected, for example, through one or more communication buses or signal lines.

In the smartphone 200, sensors, devices, and subsystems may be connected to the peripheral interface 240 so as to facilitate a number of functions. Examples of the sensors include an angular velocity sensor 250 and a magnetometer sensor 260. In the smartphone 200, a position processor 270 can be connected to the peripheral interface 240 in order to provide geographical positioning. In the smartphone 200, an accelerometer 280 can also be connected to the peripheral interface 240 in order to provide data that can be used for determining velocity changes and/or movement direction changes of a mobile device.

In the smartphone 200, a camera subsystem 290 and/or an optical sensor 300 such as a charge-coupled device and a complementary metal-oxide semiconductor optical sensor may be used in order to subserve a camera function such as photo recording and video clip recording.

The communication function of the smartphone 200 may be subserved through one or more wireless communication subsystems 310 that can include a wireless frequency receiver and transmitter, and/or an optical receiver and transmitter. The specific design and implementation of the wireless communication subsystem 310 may depend on a communication network through which the smartphone 200 operates. For example, the smartphone 200 can include a wireless communication subsystem 310 that is designed to operate through a GSM (registered trademark) network, a GPRS network, an EDGE network, a Wi-Fi network, and/or a Bluetooth (registered trademark) network. In particular, the wireless communication subsystem 310 can include a hosting protocol that enables a configuration in which the smartphone 200 serves as a base station for the scale 100.

An audio subsystem 320 may be connected to a speaker 330 and a microphone 340 in order to subserve functions that are capable of using sound such as voice recognition, voice repetition, digital recording, and telephony communication functions.

An I/O (input/output) subsystem 350 can include a touch screen controller 351, and/or one or more other input controllers 352. The touch screen controller 351 may be connected to a touch screen 360 or a pad. The touch screen 360 and the touch screen controller 351 can detect contact, movement, and/or damage, for example, using a plurality of contact tactile sensing techniques such as capacitive type, resistance type, infrared ray type, and surface acoustic wave techniques, another proximity sensor array, or another device, for determining one or more points of contact made with the touch screen 360.

In the smartphone 200, one or more of the other input controllers 352 may be connected to one or more other input/control devices 370 such as a button, a locker switch, a thumb wheel, an infrared ray port, a USB (universal serial bus) port, and/or a pointing device such as a stylus. One or more of the buttons can include up/down buttons for performing volume control of the speaker 330 and/or the microphone 340.

In a given embodiment, the smartphone 200 may be such that pressing down a given button for a first period of time releases locking of the touch screen 360 or the pad, and pressing the button down for a second period of time, which is longer than the first period of time turns the power of the device on or off. Moreover, in a given embodiment, the smartphone 200 may be such that the user can customize functions of one or more of the buttons. Furthermore, in a given embodiment, the touch screen 360 may be used to realize a virtual or soft button and/or keyboard for example.

In a given embodiment, the smartphone 200 may present recorded sound and/or video files such as MP3 (MPEG audio layer 3), AAC (advanced audio coding), and MPEG (moving picture experts group) files. In a given embodiment, the smartphone 200 may include a function of an MP3 player.

The memory interface 230 may be connected to a memory 380. The memory 380 may include a high speed random access memory, one or more magnetic disk memory devices, one or more optical memory devices, and/or a nonvolatile memory such as a flash memory. The memory 380 can store an operating system including an embedded operating system such as Darwin, RTXC, LINUX (registered trademark), UNIX (registered trademark), OSX, WINDOWS (registered trademark), or VxWorks (registered trademark). The operating system may include commands for processing basic system services and commands for executing hardware-dependent processes. In a given embodiment, the operating system may include a kernel.

Moreover, the memory 380 may store communication commands for subserving communication between one or more of the scales 100, one or more computers, and/or one or more servers. The memory 380 may include graphical user interface commands for subserving graphical user interface processes, sensor processing commands for subserving sensor-related processes and functions, telephony commands for subserving telephony-related processes and functions, electronic message processing commands for subserving electronic message-related processes and functions, web browsing commands for subserving web browsing-related processes and functions, media processing commands for subserving media processing-related processes and functions, GPS (global positioning system)/navigation commands for subserving GPS/navigation-related processes and functions, and/or camera commands for subserving camera-related processes and functions. Moreover, the memory 380 may store security commands, web video commands for subserving web video-related process and functions, and/or other software commands such as web shopping commands for subserving web shopping-related processes and functions. In a given embodiment, the media processing commands are divided into sound processing commands and video processing commands for subserving respectively sound processing-related processes and functions and video processing-related processes and functions. Furthermore, the memory 380 may store an activation record, and an international mobile equipment identifier or similar hardware identifier. The memory 380 can include magnetometer data and one or more estimated magnetic field vectors.

Each of the specific commands and applications described above may correspond to a set to commands for executing one or more of the functions described above. These commands may not have to be implemented as individual software programs, procedures, or modules. The memory 380 may include commands other than these commands, and may include a less number of commands. Furthermore, the various functions of the smartphone 200 may be carried out by means of hardware and/or software that include one or more signal processes and/or integrated circuits for specific applications.

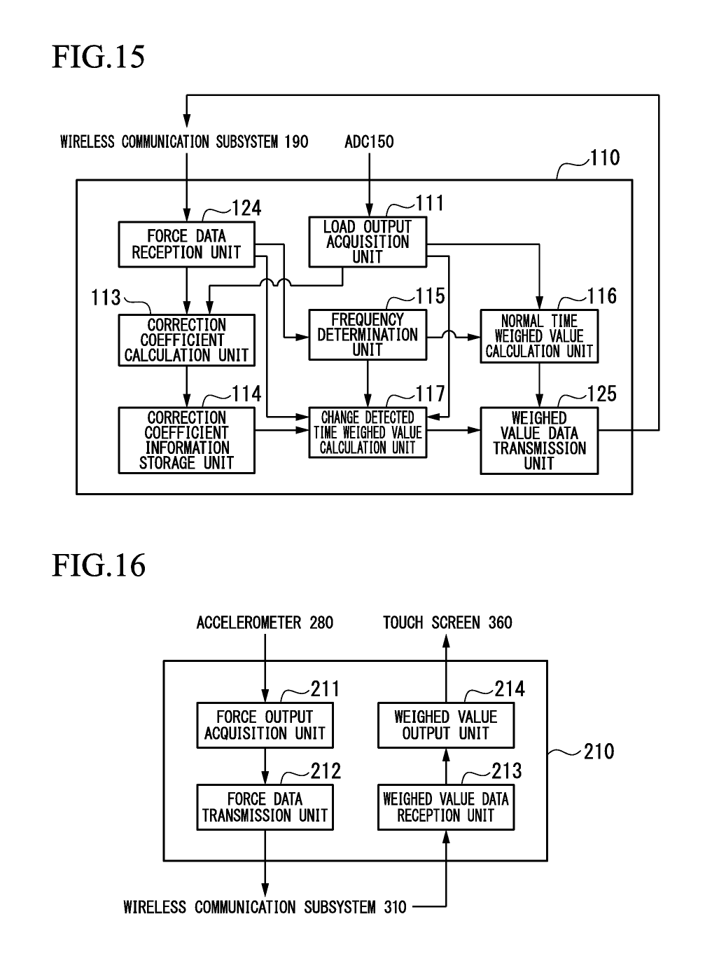

FIG. 15 shows an example of a block configuration of the processor 110 according to a fourth embodiment. The processor 110 according to the present embodiment has a load output acquisition unit 111, a force data reception unit 124, a correction coefficient calculation unit 113, a correction coefficient information storage unit 114, a frequency determination unit 115, a normal time weighed value calculation unit 116, a change detected time weighed value calculation unit 117, and a weighed value data transmission unit 125. In the following description, the function and operation of each constituent are described in detail.

The constituents of the same names with the same reference symbols among the constituents of the processor 110 of the previously described embodiments, and the processor 110 of the present embodiment, exhibit similar functions and operations.

The force data reception unit 124 receives force data indicating the output of the accelerometer 280 transmitted from the smartphone 200.

The correction coefficient calculation unit 113 treats a change amount of an output of the load cell 140 with respect to a change amount of an output of the accelerometer 280, as a correction coefficient for correcting an output of the load cell 140, based on: an output of the load cell 140 acquired by the load output acquisition unit 111 and an output of the accelerometer 280 indicated by the force data received by the force data reception unit 124, for when the smartphone 200 is attached on the scale 100 with zero load applied thereto and the scale 100 is placed in a first attitude; and an output of the load cell 140 acquired by the load output acquisition unit 111 and an output of the accelerometer 280 indicated by the force data received by the force data reception unit 124, for when the smartphone 200 is attached on the scale 100 with zero load applied thereto and the scale 100 is placed in a second attitude, which differs from the first attitude. The first attitude or the second attitude can include, for example, a horizontal attitude, a vertical attitude, an inclined attitude, or a reversed attitude.

In other words, the correction coefficient calculation unit 113 obtains a first output of the load cell 140 acquired by the load output acquisition unit 111 and a second output of the accelerometer 280 indicated by the force data received by the force data reception unit 124, for when the smartphone 200 is attached on the scale 100 with zero load applied thereto and the scale 100 is placed in a first attitude, obtains a third output of the load cell 140 acquired by the load output acquisition unit 111 and a fourth output of the accelerometer 280 indicated by the force data received by the force data reception unit 124, for when the smartphone 200 is attached on the scale 100 with zero load applied thereto and the scale 100 is placed in a second attitude, which differs from the first attitude, and treats a difference between the third output and the first output (a change amount of an output of the load cell 140) relative to a difference between the fourth output and the second output (a change amount of an output of the accelerometer 280), as a correction coefficient for correcting an output of the load cell 140.

The frequency determination unit 115 determines, in a case where a change occurs in the output of the accelerometer 280 at the time of weighing, whether or not the frequency of this change is smaller than a threshold value.

The change detected time weighed value calculation unit 117, in a case where the frequency determination unit 115 determines the frequency as being smaller than the threshold value, treats a value that is calculated by subtracting, from the output value of the load cell 140, the value obtained by multiplying the output value of the accelerometer 280 by the correction coefficient calculated by the correction coefficient calculation unit 113, as a weighed value.

The weighed value data transmission unit 125 transmits weighed value data indicating a weighed value to the smartphone 200.

FIG. 16 shows an example of a block configuration of the processor 210 according to the fourth embodiment. The processor 210 according to the present embodiment has a force output acquisition unit 211, a force data transmission unit 212, a weighed value data reception unit 213, and a weighed value output unit 214. In the following description, the function and operation of each constituent are described in detail.

The force output acquisition unit 211 acquires an output of the accelerometer 280.

The force data transmission unit 212 transmits to the scale 100, the force data indicating the output acquired by the force output acquisition unit 211.

The weighed value data reception unit 213 receives the weighed value data indicating a weighed value from the scale 100.

The weighed value output unit 214 outputs to the touch screen 360, a signal for displaying the weighed value.

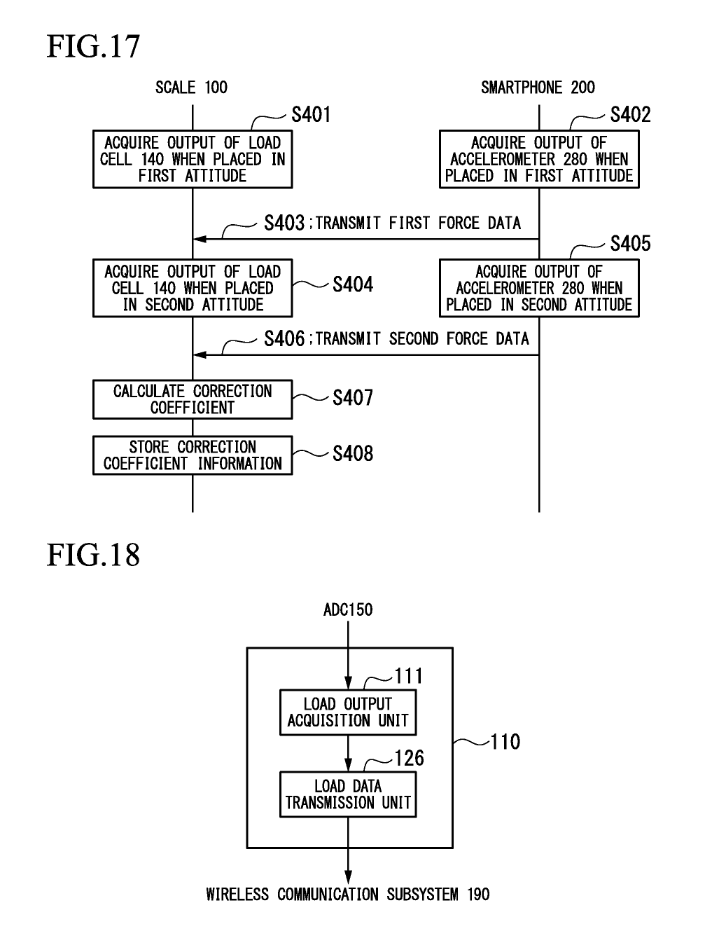

FIG. 17 shows an example of an operation sequence of the scale 100 and the smartphone 200 according to the fourth embodiment. In the description of this operation sequence, a process of setting a correction coefficient is described in detail. This operation sequence is described, with reference to FIG. 1 through FIG. 16.

When setting a correction coefficient, the operator that operates the scale 100 attaches the smartphone 200 on the attachment unit 101 of the scale 100, and connects the scale 100 and the smartphone 200 through wireless communication. The operator then switches the operation mode of the scale 100, for example, to a mode for setting a correction coefficient. Then, the operator places the scale 100 with zero load applied thereto in the first attitude, and performs, for example, a predetermined first operation to make the processor 110 of the scale 100 and the processor 210 of the smartphone 200 recognize the scale 100 as having been placed in the first attitude. As the first attitude, the operator places the scale 100 so that the load receiving unit 130 is positioned on the upper side for example. As the predetermined first operation, the operator then presses down a button provided for making the processor 110 of the scale 100 and the processor 210 of the smartphone 200 recognize the scale 100 as having been placed in the first attitude for example.

Once the predetermined first operation has been performed, the load output acquisition unit 111 of the processor 110 of the scale 100 performs a process similar to the process in step S101 of FIG. 4 to acquire an output of the load cell 140 (S401). The load output acquisition unit 111 then outputs to the correction coefficient calculation unit 113, the first load data indicating the acquired output value.

On the other hand, once the predetermined first operation has been performed, the force output acquisition unit 211 of the processor 210 of the smartphone 200 performs a process similar to the process of the scale 100 in step S102 of FIG. 4 to acquire an output of the accelerometer 280 (S402). The force output acquisition unit 211 then outputs to the force data transmission unit 212, the first force data indicating the acquired output value.

Upon receiving the first force data, the force data transmission unit 212 of the processor 210 of the smartphone 200 transmits the first force data to the scale 100 through the wireless communication subsystem 310 (S403).

Next, the operator places the scale 100 with zero load applied thereto in the second attitude, and performs, for example, a predetermined second operation to make the processor 110 of the scale 100 and the processor 210 of the smartphone 200 recognize the scale 100 as having been placed in the second attitude. As the second attitude, the operator places the scale 100 so that the load receiving unit 130 is positioned on the lower side for example. As the predetermined second operation, the operator then presses down a button provided for making the processor 110 of the scale 100 and the processor 210 of the smartphone 200 recognize the scale 100 as having been placed in the second attitude for example.

Once the predetermined second operation has been performed, the load output acquisition unit 111 of the processor 110 of the scale 100 performs a process similar to the process in step S103 of FIG. 4 to acquire an output of the load cell 140 (S404). The load output acquisition unit 111 then outputs to the correction coefficient calculation unit 113, the second load data indicating the acquired output value.

On the other hand, once the predetermined second operation has been performed, the force output acquisition unit 211 of the processor 210 of the smartphone 200 performs a process similar to the process of the scale 100 in step S104 of FIG. 4 to acquire an output of the accelerometer 280 (S405). The force output acquisition unit 211 then outputs to the force data transmission unit 212, the second force data indicating the acquired output value.

Upon receiving the second force data, the force data transmission unit 212 of the processor 210 of the smartphone 200 transmits the second force data to the scale 100 through the wireless communication subsystem 310 (S406).

Upon receiving the first load data, the first force data, the second load data, and the second force data respectively, the correction coefficient calculation unit 113 of the processor 110 of the scale 100 performs a process similar to the process in step S105 of FIG. 4, and treats the change amount of the output of the load cell 140 with respect to the change amount of the output of the accelerometer 280 as a correction coefficient for correcting the output of the load cell 140 (S407). The correction coefficient calculation unit 113 stores information indicating the calculated correction coefficient into the correction coefficient information storage unit 114 (S407). In this manner, a correction coefficient is set in the scale 100. This correction coefficient is referenced when calculating a weighed value as with the embodiments described above. In the weighing system, the accelerometer 280 of the smartphone 200 is used also when calculating a weighed value.

As described above, the weighing system is a system that weighs the mass of an object (measures the mass of an object). The weighing system is provided with a scale 100 that is provided with a load receiving unit 130 provided for receiving a load, and a load cell 140 provided for detecting a load acting on the load receiving unit 130. Moreover, the weighing system is provided with a smartphone 200 that is detachably provided on the scale 100 and includes an accelerometer 280 provided for detecting an acceleration, which is a force acting on the scale 100. The scale 100 of the present embodiment acquires an output of the load cell 140. On the other hand, the smartphone 200 according to the present embodiment 200 acquires an output of the accelerometer 280. The smartphone 200 then transmits to the scale 100, the force data indicating the acquired output. The scale 100 receives the force data transmitted from the smartphone 200. The scale 100 treats a change amount of an output of the load cell 140 with respect to a change amount of an output of the accelerometer 280, as a correction coefficient for correcting the output of the load cell 140, based on: an output of the load cell 140 acquired and an output of the accelerometer 280 indicated by the force data received, for when the smartphone 200 is attached on the scale 100 with zero load applied thereto and the scale 100 is placed in a first attitude; and an output of the load cell 140 acquired and an output of the accelerometer 280 indicated by the force data received, for when the smartphone 200 is attached on the scale 100 with zero load applied thereto and the scale 100 is placed in a second attitude, which differs from the first attitude.

In this manner, in the weighing system according to the present embodiment, it is possible to calculate the change amount of the output of the load cell 140 with respect to the change amount of the output of the accelerometer 160 as a correction coefficient for correcting the output of the load cell 140, with use of the smartphone 200, which is provided with the accelerometer 280, and without using a specialized apparatus such as one that applies a standard reference vibration to the scale 100.

FIG. 18 shows an example of a block configuration of the processor 110 according to a fifth embodiment. The processor 110 according to the present embodiment has a load output acquisition unit 111, and a load data transmission unit 126. In the following description, the function and operation of each constituent are described in detail.

The constituents of the same names with the same reference symbols among the constituents of the processor 110 of the previously described embodiments, and the processor 110 of the present embodiment, exhibit similar functions and operations.

The load data transmission unit 126 transmits to the smartphone 200, the load data indicating the output acquired by the load output acquisition unit 111.

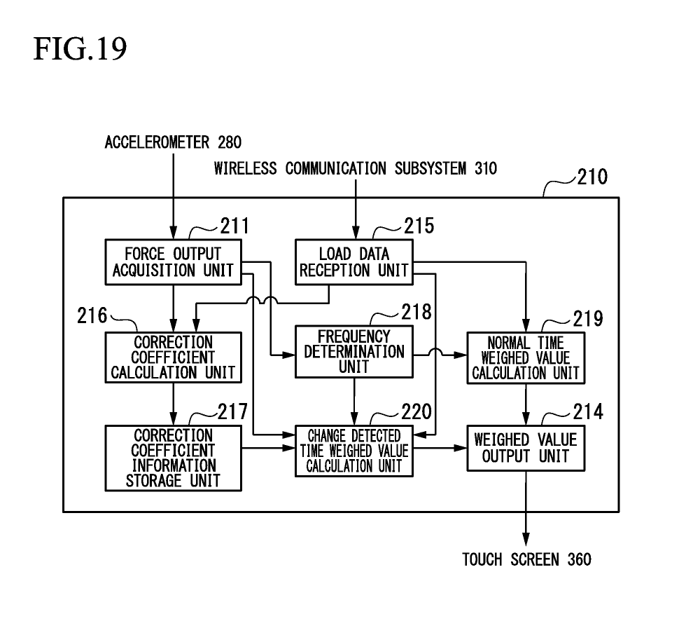

FIG. 19 shows an example of a block configuration of the processor 210 according to the fifth embodiment. The processor 210 according to the present embodiment has a load data reception unit 215, a force output acquisition unit 211, a correction coefficient calculation unit 216, a correction coefficient information storage unit 217, a frequency determination unit 218, a normal time weighed value calculation unit 219, a change detected time weighed value calculation unit 220, and a weighed value output unit 214. In the following description, the function and operation of each constituent are described in detail.

The constituents of the same names with the same reference symbols among the constituents of the processor 210 of the previously described embodiments, and the processor 210 of the present embodiment, exhibit similar functions and operations.

The load data reception unit 215 receives the load data transmitted from the scale 100.

The correction coefficient calculation unit 216 treats a change amount of an output of the load cell 140 with respect to a change amount of an output of the accelerometer 280, as a correction coefficient for correcting an output of the load cell 140, based on: an output of the load cell 140 indicated by the load data received by the load data reception unit 215 and an output of the accelerometer 280 acquired by the force output acquisition unit 211, for when the smartphone 200 is attached on the scale 100 with zero load applied thereto and the scale 100 is placed in a first attitude; and an output of the load cell 140 indicated by the load data received by the load data reception unit 215 and an output of the accelerometer 280 acquired by the force output acquisition unit 211, for when the smartphone 200 is attached on the scale 100 with zero load applied thereto and the scale 100 is placed in a second attitude, which differs from the first attitude. The first attitude or the second attitude can include, for example, a horizontal attitude, a vertical attitude, an inclined attitude, or a reversed attitude.

In other words, the correction coefficient calculation unit 216 obtains a first output of the load cell 140 indicated by the load data received by the load data reception unit 215 and a second output of the accelerometer 280 acquired by the force output acquisition unit 211, for when the smartphone 200 is attached on the scale 100 with zero load applied thereto and the scale 100 is placed in a first attitude, obtains a third output of the load cell 140 indicated by the load data received by the load data reception unit 215 and a fourth output of the accelerometer 280 acquired by the force output acquisition unit 211, for when the smartphone 200 is attached on the scale 100 with zero load applied thereto and the scale 100 is placed in a second attitude, which differs from the first attitude, and treats a difference between the third output and the first output (a change amount of an output of the load cell 140) relative to a difference between the fourth output and the second output (a change amount of an output of the accelerometer 280), as a correction coefficient for correcting an output of the load cell 140.

The correction coefficient information storage unit 217 stores information of correction coefficients calculated by the correction coefficient calculation unit 216.

The frequency determination unit 218 determines, in a case where a change occurs in the output of the accelerometer 280 at the time of weighing, whether or not the frequency of this change is smaller than a threshold value.

The normal time weighed value calculation unit 219 takes the output value of the load cell 140 as a weighed value.

The change detected time weighed value calculation unit 220, in a case where the frequency determination unit 218 determines the frequency as being smaller than the threshold value, treats a value that is calculated by subtracting, from the output value of the load cell 140, the value obtained by multiplying the output value of the accelerometer 280 by the correction coefficient calculated by the correction coefficient calculation unit 216, as a weighed value.

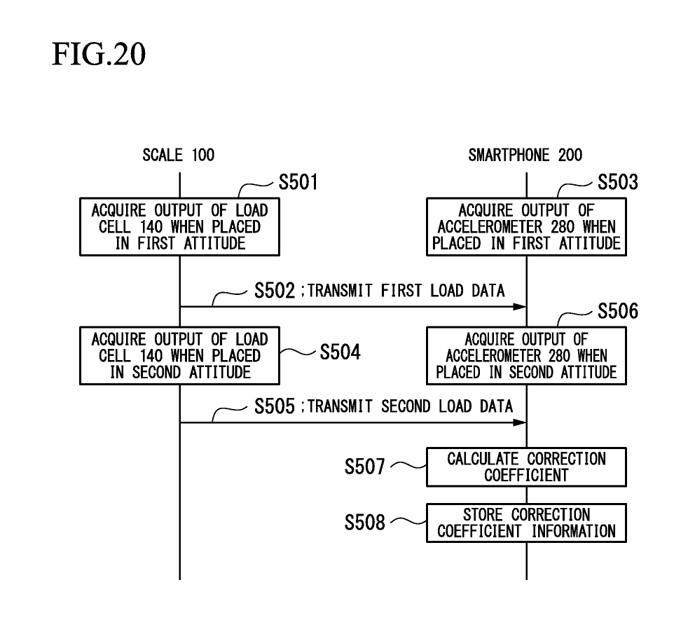

FIG. 20 shows an example of an operation sequence of the scale 100 and the smartphone 200 according to the fifth embodiment. In the description of this operation sequence, a process of setting a correction coefficient is described in detail. This operation sequence is described, with reference to FIG. 1 through FIG. 19.

When setting a correction coefficient, the operator that operates the scale 100 attaches the smartphone 200 on the attachment unit 101 of the scale 100, and connects the scale 100 and the smartphone 200 through wireless communication. The operator then switches the operation mode of the scale 100, for example, to a mode for setting a correction coefficient. Then, the operator places the scale 100 with zero load applied thereto in the first attitude, and performs, for example, a predetermined first operation to make the processor 110 of the scale 100 and the processor 210 of the smartphone 200 recognize the scale 100 as having been placed in the first attitude. As the first attitude, the operator places the scale 100 so that the load receiving unit 130 is positioned on the upper side for example. As the predetermined first operation, the operator then presses down a button provided for making the processor 110 of the scale 100 and the processor 210 of the smartphone 200 recognize the scale 100 as having been placed in the first attitude for example.

Once the predetermined first operation has been performed, the load output acquisition unit 111 of the processor 110 of the scale 100 performs a process similar to the process in step S101 of FIG. 4 to acquire an output of the load cell 140 (S501). The load output acquisition unit 111 then outputs to the load data transmission unit 126, the first load data indicating the acquired output value.

Upon receiving the first load data, the load data transmission unit 126 of the processor 110 of the scale 100 transmits the first load data to the smartphone 200 through the wireless communication subsystem 190 (S502).

On the other hand, once the predetermined first operation has been performed, the force output acquisition unit 211 of the processor 210 of the smartphone 200 performs a process similar to the process of the scale 100 in step S102 of FIG. 4 to acquire an output of the accelerometer 280 (S503). The force output acquisition unit 211 then outputs to the correction coefficient calculation unit 216, the first force data indicating the acquired output value.

Next, the operator places the scale 100 with zero load applied thereto in the second attitude, and performs, for example, a predetermined second operation to make the processor 110 of the scale 100 and the processor 210 of the smartphone 200 recognize the scale 100 as having been placed in the second attitude. As the second attitude, the operator places the scale 100 so that the load receiving unit 130 is positioned on the lower side for example. As the predetermined second operation, the operator then presses down a button provided for making the processor 110 of the scale 100 and the processor 210 of the smartphone 200 recognize the scale 100 as having been placed in the second attitude for example.

Once the predetermined second operation has been performed, the load output acquisition unit 111 of the processor 110 of the scale 100 performs a process similar to the process in step S103 of FIG. 4 to acquire an output of the load cell 140 (S504). The load output acquisition unit 111 then outputs to the load data transmission unit 126, the second load data indicating the acquired output value.

Upon receiving the second load data, the load data transmission unit 126 of the processor 110 of the scale 100 transmits the second load data to the smartphone 200 through the wireless communication subsystem 190 (S505).

On the other hand, once the predetermined second operation has been performed, the force output acquisition unit 211 of the processor 210 of the smartphone 200 performs a process similar to the process of the scale 100 in step S104 of FIG. 4 to acquire an output of the accelerometer 280 (S506). The force output acquisition unit 211 then outputs to the correction coefficient calculation unit 216, the second force data indicating the acquired output value.

Upon receiving the first load data, the first force data, the second load data, and the second force data respectively, the correction coefficient calculation unit 216 of the processor 210 of the smartphone 200 performs a process similar to the process of the scale 100 in step S105 of FIG. 4, and treats the change amount of the output of the load cell 140 with respect to the change amount of the output of the accelerometer 280 as a correction coefficient for correcting the output of the load cell 140 (S507). The correction coefficient calculation unit 216 then stores information indicating the calculated correction coefficient into the correction coefficient information storage unit 217 (S508). In this manner, a correction coefficient is set in the smartphone 200. This correction coefficient is referenced when calculating a weighed value as with the embodiments described above. In the weighing system, the accelerometer 280 of the smartphone 200 is used also when calculating a weighed value.

As described above, the scale 100 of the present embodiment acquires an output of the load cell 140. The scale 100 then transmits to the smartphone 200, the load data indicating the acquired output. On the other hand, the smartphone 200 acquires an output of the accelerometer 280.

Moreover, the smartphone 200 receives the load data transmitted from the scale 100. The smartphone 200 then treats a change amount of an output of the load cell 140 with respect to a change amount of an output of the accelerometer 280, as a correction coefficient for correcting an output of the load cell 140, based on: an output of the load cell 140 indicated by the load data received by the load data reception unit 215 and an output of the accelerometer 280 acquired by the force output acquisition unit 211, for when the smartphone 200 is attached on the scale 100 with zero load applied thereto and the scale 100 is placed in a first attitude; and an output of the load cell 140 indicated by the load data received by the load data reception unit 215 and an output of the accelerometer 280 acquired by the force output acquisition unit 211, for when the smartphone 200 is attached on the scale 100 with zero load applied thereto and the scale 100 is placed in a second attitude, which differs from the first attitude.

In this manner, according to the weighing system according to the present embodiment, it is possible to calculate the change amount of the output of the load cell 140 with respect to the change amount of the output of the accelerometer 160 as a correction coefficient for correcting the output of the load cell 140, with use of the smartphone 200, which is provided with the accelerometer 280, and without using a specialized apparatus such as one that applies a standard reference vibration to the scale 100.

The functions described can be carried out by a digital electronic circuit, computer hardware, firmware, and software, or by a combination of them. The functions, in order to execute them on a programmable processor, can be performed in steps of a method that can be executed by means of: an information carrier such as a computer program product that is realized as a tangible object on a device-readable memory device; and a programmable processor that executes command programs for executing the embodiments described above by operating input data and generating an output. Furthermore, alternatively, program commands may be artificially generated propagating signals such as electric, optic, or electromagnetic signals generated by a device, and, in order for the program commands to be executed on a programmable processor, the program commands may be encoded into signals generated to encode information to be transmitted to an appropriate receiver device.

The functions described above can be suitably carried out by means of one or more computer programs that can be executed on a programmable system that includes one or more programmable processors that transmits and receives data and commands between a data storage system, at least one input device, and at least one output device. The computer program is a set of commands that can be used to directly or indirectly execute predetermined operations by means of a computer, and obtain predetermined results. The computer program can be coded in a programming language of an arbitrary format including compiling language and interpreter language, and may be arranged in an arbitrary format including a standalone program, module, component, sub-routine, and another unit suitable to be used in a computing environment.

Examples of the processor that is suitable for command program execution include both general purpose and specific purpose microprocessors and a single or a plurality of processors or cores of a computer of an arbitrary type. In general, a processor receives commands and data from at least either a dedicated memory for reading commands and data or a random access memory. Basic components of the computer are a processor for executing commands, and one or more memories for storing commands and data. Generally, the computer may further include or be operatively connected to one or more high capacity memory storage devices including a magnetic disk, a magnetic optical disk, and an optical disk such as a built-in hard disk and removable disk. Examples of the memory storage device suitable for tangibly realizing computer program commands and data include a semiconductor memory device such as EPROM (erasable programmable read only memory), EEPROM (electrically erasable and programmable read only memory), and flash memory device, and a nonvolatile memory of an arbitrary format such as a CD-ROM (compact disk read only memory) disk and a DVD-ROM (digital versatile disk read only memory) disk. The processor and memory may use a plurality of ASICs (application specific integrated circuit) for subserving purposes, or may be embedded in an ASIC.

In order to provide interaction with the user, it may be executed on a computer that has a display device for displaying information to the user such as a CRT (cathode ray tube) monitor and an LCD (liquid crystal display) monitor, a keyboard that enables the user to make input to the computer, and a pointing device such as a mouse and track ball.

The functions can be performed by means of a computer system that includes back-end components such as a data server, a computer system that includes middleware components such as an application server and an Internet server, or a computer system that includes front-end components such as a client computer having a graphical user interface, an Internet browser, or a combination of these. The constituents of the system may be connected via digital data communication of an arbitrary format or medium such as a communication network. Examples of the communication network include LAN (local area network), WAN (wide area network), and computers and networks that form the Internet.

The computer system can include a client and a server. The client and the server are usually remote each other, and communicate with each other typically through a network. The relationship between the client and the server is realized by computer programs running on the respective computers, mutually forming a client-server relationship.

One or more functions and steps of the above embodiment may be implemented, using an API (application program interface). An API can provide a service, provide data, and define one or more parameters that are exchanged between a calling application that executes operations and calculations, and other software codes.

The API may be implemented as one or more calls within the parameter list based on the calling method defined in the API specification documentation, or within a program code that transmits or receives one or more parameters through another structure. The parameters may be constants, keys, data structures, objects, object classes, variables, data types, pointers, matrixes, lists, or other calls. API calls and parameters may be implemented by means of an arbitrary programming language. A programming language can define vocabularies and calling methods used by a programmer in order to access functions that support an API.

In a given embodiment, an API call can report the ability of the device that is executing the application to an application.

The present invention has been described, using the embodiments. However, the technical scope of the invention is not limited by the scope described in the embodiments above. As will be understood by the skilled person, various modifications or improvements may be made to the above embodiments. Such modifications or improvements may be included in the technical scope of the present invention as clearly understood from disclosure of the claims of the invention.

The execution order of the respective processes of the operations, procedures, steps, and stages in the system, method, apparatus, program, and recording medium illustrated in the claims, specification, and drawings are not explicitly described in particular manners such as “prior to” or “in advance”. It should be noted that executions may be realized in an arbitrary order unless output of a previous process is used in a subsequent process. Even if expressions such as “first”, “next”, or the like are used in the description in relation to the operation flows in the claims, specification, and drawings, it does not mean that the execution in this particular order is essential.

What is claimed is:

1. A weighing apparatus for weighing a mass of an object, the apparatus comprising:
a main body;
a load receiving device provided at the main body to receive a load;
a load detection device provided to detect a load acting on the load receiving device;
an acting force detection device provided to detect a force that is acting on the main body and that differs from the load acting on the load receiving device; and
a data processing device configured to data-process an output of the load detection device as a weighed value in a mass unit,
the data processing device having:
a load output acquisition unit configured to acquire an output of the load detection device;
a force output acquisition unit configured to acquire an output of the acting force detection device; and
a correction coefficient calculation unit configured to calculate, as a correction coefficient for correcting an output of the load detection device, a change amount of an output of the load output acquisition unit with respect to a change amount of an output of the acting force detection device based on (i) outputs of the load detection device and the acting force detection device acquired respectively by the load output acquisition unit and the force output acquisition unit, when the main body with zero load applied thereto is placed in a first attitude and (ii) outputs of the load detection device and the acting force detection device acquired respectively by the load output acquisition unit and the force output acquisition unit, when the main body with zero load applied thereto is placed in a second attitude, which differs from the first attitude.

2. The weighing apparatus according to claim 1, wherein
the data processing device further has:
a frequency determination unit that, in a case where a change occurs in an output of the acting force detection device at the time of weighing, determines whether or not a frequency of the change is smaller than a threshold value; and
a change detected time weighed value calculation unit that, in a case where the frequency determination unit determines the frequency as being smaller than the threshold value, treats a value that is calculated by subtracting, from an output of the load detection device, a value obtained by multiplying an output of the acting force detection device by a correction coefficient calculated by the correction coefficient calculation unit, as a weighed value.

3. The weighing apparatus according to claim 1, wherein
the data processing device further has:
an output difference determination unit that determines whether or not an output difference between an output of the acting force detection device when a display is automatically set to zero without intervention of an operator, and an output of the acting force detection device at a time of weighing, is within an acceptable value; and
an output difference detected time weighed value calculation unit that, in a case where the output difference determination unit determines the output difference as not being within the acceptable value, treats a value that is calculated by subtracting from an output of the load detection device, a value obtained by multiplying the output difference by a correction coefficient calculated by the correction coefficient calculation unit, as a weighed value.

4. The weighing apparatus according to claim 1, wherein
the data processing device further has:
a span coefficient calculation unit that treats as a span coefficient of the load detection device after shipment, a value that is calculated by multiplying a value obtained by dividing a correction coefficient calculated after shipment by the correction coefficient calculation unit by a correction coefficient calculated before shipment by the correction coefficient calculation unit, by a span coefficient of the load detection unit obtained before shipment.

5. The weighing apparatus according to claim 1, wherein at least one of the acting force detection device, the load output acquisition unit, the force output acquisition unit, and the correction coefficient calculation unit of the data processing device is provided at another body that is different from the main body.

6. The weighing apparatus according to claim 5, wherein
the acting force detection device is provided at the another body,
the another body is attachably and detachably provided with respect to the main body, and
the acting force detection device detects, while the another body is attached on the main body, the force that is acting on the main body and that differs from the load acting on the load receiving device.

7. The weighing apparatus according to claim 6, wherein the another body is a portable information terminal.

8. A weighing system comprising:
a weighing apparatus configured to measure a mass of an object;
a portable information terminal; and
a data processing section configured to process data for the measurement, wherein
the weighing apparatus comprises:
a load receiving unit, and
a load detection device arranged to detect a load acting on the load receiving unit,
the portable information terminal comprises:
an acting force detection device arranged to detect a force that is acting on the weighing apparatus,
the data processing section comprises:
a load output acquisition unit provided at the weighing apparatus and configured to acquire an output of the load detection device;
a force output acquisition unit provided at the portable information terminal and configured to acquire an output of the acting force detection device; and
a correction coefficient calculation unit provided at the weighing apparatus or at the portable information terminal and configured to calculate a correction coefficient for correcting an output of the load detection device.

9. The weighing system according to claim 8, wherein
the system is arranged such that the portable information terminal is attachably and detachably provided with respect to the weighing apparatus, and
the acting force detection device is arranged to detect, while the portable information terminal is attached on the weighing apparatus, the force that is acting on the weighing apparatus and that differs from the load acting on the load receiving unit.

10. The weighing system according to claim 8, wherein
the portable information terminal further comprises a force data transmission unit configured to transmit to the weighing apparatus, force data indicating an output acquired by the force output acquisition unit,
the weighing apparatus further comprises a force data reception unit configured to receive the force data transmitted from the portable information terminal, and
the correction coefficient calculation unit is provided at the weighing apparatus and configured to calculate, as the correction coefficient, a change amount of an output of the load detection device with respect to a change amount of an output of the acting force detection device based on (i) an output of the load detection device that is acquired by the load output acquisition unit and an output of the acting force detection device that is shown by force data received by the force data reception unit, when the portable information terminal is attached on the weighing apparatus with zero load applied thereto and the weighing apparatus is placed in a first attitude, (ii) an output of the load detection device that is acquired by the load output acquisition unit and an output of the acting force detection device that is shown by force data received by the force data reception unit, when the portable information terminal is attached on the weighing apparatus with zero load applied thereto and the weighing apparatus is placed in a second attitude, which differs from the first attitude.

11. The weighing system according to claim 8, wherein
the weighing apparatus further comprises a load data transmission unit that transmits to the portable information terminal, load data indicating the output acquired by the load output acquisition unit,
the portable information terminal further comprises a load data reception unit that receives the load data transmitted from the weighing apparatus, and
the correction coefficient calculation unit is provided at the portable information terminal and configured to calculate, as the correction coefficient, a change amount of an output of the load detection device with respect to a change amount of an output of the acting force detection device based on (i) an output of the load detection device that is shown by the load data received by the load data reception unit and an output of the acting force detection device that is acquired by the force output acquisition unit, when the portable information terminal is attached on the weighing apparatus with zero load applied thereto and the weighing apparatus is placed in a first attitude and (ii) an output of the load detection device that is shown by the load data received by the load data reception unit and an output of the acting force detection device that is acquired by the force output acquisition unit, when the portable information terminal is attached on the weighing apparatus with zero load applied thereto and the weighing apparatus is placed in a second attitude, which differs from the first attitude.

12. A weighing method for weighing a mass of an object, the method comprising:
(a) acquiring an output of a load detection device that is provided at a body of a weighing apparatus for detecting a load acting on a load receiving device of the body;
(b) acquiring an output of an acting force detection device that is provided for detecting a force that is acting on the body and that differs from a load that is acting on the load receiving device; and
(c) calculating, as a correction coefficient for correcting an output of the load detection device, a change amount of an output of the load detection device with respect to a change amount of an output of the acting force detection device based on (i) outputs of the load detection device and the acting force detection device acquired respectively in the step (a) and the step (b), when the body with zero load applied thereto is placed in a first attitude and (ii) outputs of the load detection device and the acting force detection device acquired respectively in the step (a) and the step (b), when the body with zero load applied thereto is placed in a second attitude, which differs from the first attitude.

13. The weighing method according to claim 12, wherein
the output of the load detection device is acquired by means of a weighing apparatus
the output of the acting force detection device is acquired by means of a portable information terminal that is attachably and detachably provided with respect to the body of the weighing apparatus and that is provided with the acting force detection device,
the method further comprises:
(d) transmitting force data showing the output of the acting force detection device acquired in the step (b), to the weighing apparatus by means of the portable information terminal; and
(e) receiving the force data transmitted from the portable information terminal, by means of the weighing apparatus, and
in the step (c), by means of the weighing apparatus, as the correction coefficient, a change amount of the output of the load detection device with respect to a change amount of the output of the acting force detection device is calculated based on (i) an output of the load detection device that is acquired in the step (a) and an output of the acting force detection device that is shown by the force data received in the step (d), when the portable information terminal is attached on the body with zero load applied thereto and the body is placed in a first attitude and (ii) an output of the load detection device that is acquired in the step (a) and an output of the acting force detection device that is shown by the force data received in the step (d), when the portable information terminal is attached on the body with zero load applied thereto and the body is placed in a second attitude, which differs from the first attitude.

14. The weighing method according to claim 12, wherein
the output of the load detection device is acquired by means of the weighing apparatus
the output of the acting force detection device is acquired by means of a portable information terminal that is attachably and detachably provided with respect to the body of the weighing apparatus and that is provided with the acting force detection device,
the method further comprises:
(d) by means of the weighing apparatus, transmitting load data indicating the output acquired in the step (a) to the portable information terminal; and
(e) receiving the load data transmitted from the weighing apparatus, by means of the portable information terminal, and
in the step (c), by means of the portable information terminal, as the correction coefficient, a change amount of the output of the load detection device with respect to a change amount of the output of the acting force detection device is calculated based on (i) an output of the load detection device that is shown by the load data received in the step (d) and an output of the acting force detection device that is acquired in the step (c), when the portable information terminal is attached on the body with zero load applied thereto and the body is placed in a first attitude and (ii) an output of the load detection device that is shown by the load data received in the step (d) and an output of the acting force detection device that is acquired in the step (c), when the portable information terminal is attached on the body with zero load applied thereto and the body is placed in a second attitude, which differs from the first attitude.

15. A recording medium that records a program that causes the steps of the weighing method of claim 12.
